(19) United States
(12) Patent Application Publication
(10) Pub. No.: US 2011/0301860 A1
(43) Pub. Date: Dec. 8, 2011

(54) USING DIFFERENTIAL SCANNING CALORIMETRY (DSC) FOR DETECTION OF INFLAMMATORY DISEASE

(75) Inventors: Jonathan B. Chaires, Louisville, KY (US); Nichola C. Garbett, Louisville, KY (US); A. Bennett Jenson, Louisville, KY (US); Albert S. Benight, Milwaukie, OR (US); Greg P. Brewood, Beaverton, OR (US); Daniel J. Fish, Portland, OR (US)

(73) Assignees: LOUISVILLE BIOSCIENCE, INC., Louisville, KY (US); UNIVERSITY OF LOUISVILLE RESEARCH FOUNDATION, INC., Louisville, KY (US)

(21) Appl. No.: 13/157,275

(22) Filed: Jun. 9, 2011

Related U.S. Application Data
(63) Continuation-in-part of application No. 12/561,081, filed on Sep. 16, 2009.
Application No. 12/561,081 is a continuation-in-part of application No. 11/972,921, filed on Jan. 11, 2008.
(60) Provisional application No. 61/352,945, filed on Jun. 9, 2010.
(60) Provisional application No. 61/097,433, filed on Sep. 16, 2008.
(60) Provisional application No. 60/978,252, filed on Oct. 8, 2007.
(60) Provisional application No. 60/884,730, filed on Jan. 12, 2007.

(51) Int. Cl. G06F 19/10

(52) U.S. Cl. 702/19

(57) ABSTRACT

Disclosed herein in various embodiments are systems and methods for categorizing biological fluids obtained from subjects into one or more disease or treatment categories. Embodiments of the systems and methods may transform easily obtainable body fluids such as blood, plasma, spinal fluid, and other fluids into signature differential scanning calorimetry (DSC) thermograms that may be used to distinguish a positive or negative correlation with a specific inflammatory disease, such as an autoimmune disease. Also disclosed are methods of detecting, diagnosing, and/or monitoring an inflammatory disease in a subject.

### CROSS REFERENCE TO RELATED APPLICATIONS

This application is a continuation-in-part of and claims priority to U.S. patent application Ser. No. 12/561,081, titled “PROFILING METHOD USEFUL FOR CONDITION DIAGNOSIS AND MONITORING, COMPOSITION SCREENING, AND THERAPEUTIC MONITORING,” filed on Sep. 16, 2009, which was, in turn, a continuation-in-part of U.S. patent application Ser. No. 11/972,921, which was filed on Jan. 11, 2008, and which application also claimed priority to U.S. Provisional Application No. 61/097,433, filed on Sep. 16, 2008. U.S. patent application Ser. No. 11/972,921 also claimed priority to U.S. Provisional Patent Application No. 60/978,252, filed on Oct. 8, 2007; and U.S. Provisional Patent Application No. 60/884,730, filed on Jan. 12, 2007. The disclosures of all of the above are hereby incorporated by reference in their entireties.

The present application also claims priority to U.S. Provisional Patent Application Ser. No. 61/352,945, titled: “USING DIFFERENTIAL SCANNING CALORIMETRY (DSC) OF PLASMA FOR EARLY DETECTION OF AUTOIMMUNE DISEASE,” filed on Jun. 9, 2010, the entire disclosure of which is hereby incorporated by reference.

### TECHNICAL FIELD

Embodiments herein relate to the detection of inflammatory disease, and, more specifically, to detection methods using differential scanning calorimetry (DSC) to detect autoimmune disease.

### BACKGROUND

Autoimmune diseases involve aberrant regulation of cellular and humoral mediated immunity and are frequently associated with abnormal or enhanced T cell, B cell and macrophage effector functions directed towards self antigens. The activation of these cellular components towards self antigens is believed related to the break in feedback mechanisms associated with self tolerance. Autoimmune diseases encompass a large spectrum of clinical entities, and despite the differences in the target organ, have many similarities. While the presence of autoantibodies, inappropriate expression of class II antigens, macrophage activation, and T cell infiltration to the target organ have been described in essentially all of the autoimmune diseases, neither the triggering mechanisms that result in disease activation nor factors involved in disease progression are well understood. Treatment of autoimmune diseases has not improved significantly over the past decade and primarily is associated with the use of nonsteroidal and steroidal anti-inflammatory agents to treat the symptoms of the disease. However, generalized immunosuppression has major liabilities in terms of side effects and the propensity of the immunosuppressed subject to be at greater risk for other infectious and non-infectious diseases.

### BRIEF DESCRIPTION OF THE DRAWINGS

Embodiments will be readily understood by the following detailed description in conjunction with the accompanying drawings. Embodiments are illustrated by way of example and not by way of limitation in the figures of the accompanying drawings.

FIG. 1A shows a plot of all DSC plasma thermograms collected from over 500 healthy (normal control) subjects (fine lines 105), a median DSC plasma thermogram (solid line 115), and 90% quintiles (dashed lines 125), in accordance with various embodiments;

FIG. 1B shows an average DSC plasma thermogram from normal (control) individuals, in accordance with various embodiments;

FIG. 2 shows a comparison of DSC plasma thermograms from diseased and healthy (normal control) plasma, where diseased samples were taken from subjects diagnosed with rheumatoid arthritis (RA, top), myositis (middle), and systemic lupus erythematosis (SLE; bottom), in accordance with various embodiments;

FIG. 3 shows a DSC plasma thermogram logic tree for the analysis and identification of inflammatory disease from specific types of DSC plasma thermogram databases, in accordance with various embodiments;

FIG. 4 shows a stratification of normal control DSC plasma thermograms by ethnicity, where the population of Hispanic DSC plasma thermograms (dashed dotted line) is significantly different from Caucasian (solid line) and African-American (dashed line), in accordance with various embodiments;

FIG. 5 shows DSC plasma thermograms from individuals with SLE and normal controls, where normal control DSC plasma thermograms (cluster A, solid lines) and SLE DSC plasma thermograms (cluster B, dashed lines) naturally cluster into two populations, and the curves display over 300 DSC plasma thermograms from both populations, in accordance with various embodiments;

FIG. 6 illustrates box plots of data from normal control DSC plasma thermograms at various temperature points, where boxes (610) represent the range between the 5% and 95% quantiles, horizontal lines (620) represent median values at each temperature, small crosses (630) represent data points that fall outside of the quantile range, and the mean DSC plasma thermogram is plotted as a dashed curve (640), in accordance with various embodiments;

FIG. 7 shows a comparison of a test DSC plasma thermogram Xₜₑₛₜ(T) (solid line) to a reference median DSC plasma thermogram X_{ref}(T) (dashed line) with a 90% quantile distance a ref (grey-shading), in accordance with various embodiments;

FIG. 8 shows a comparison of healthy normal control (dotted curve) and SLE (dashed curve) test DSC plasma thermograms to the reference median DSC plasma thermogram (solid curve), where grey shaded curves represent the 90% quantile band around the median, in accordance with various embodiments;

FIG. 9 shows examples of simulated DSC plasma thermograms generated by the sum of the healthy (normal control) reference DSC plasma thermogram and randomly generated Gaussians, where a simulated ‘known similar’ DSC plasma thermogram with component protein concentration within the 90% quantile range is shown as a solid line, and a simulated “known different” DSC plasma thermogram with component protein concentration outside of the 90% quantile range is shown as a dashed line, in accordance with various embodiments;

FIG. 10 shows an example of a histogram of variances of SLE (left) and healthy (normal control, right) DSC plasma thermograms calculated at each temperature point, where the average variances are indicated with dashed vertical lines, in accordance with various embodiments;

FIG. 11 shows DSC plasma thermograms obtained for samples from subjects with cervical melanoma and lung cancers, in accordance with various embodiments;

FIG. 12 shows DSC plasma thermograms that display characteristic shapes associated with different stages of cervical cancer, in accordance with various embodiments;

FIG. 13 shows DSC plasma thermograms that display characteristic shapes associated with different stages of melanoma, in accordance with various embodiments;

FIG. 14 shows a cluster analysis indicating a significant difference between SLE and normal control data sets, in accordance with various embodiments;

FIG. 15 shows diagnostic results illustrating that different average DSC plasma thermograms from each disease category indicate the compositions of samples are clearly different from each other, and an ROC curve analysis shows that samples may be distinguished from each other in a statistically and clinically relevant manner, in accordance with various embodiments;

FIG. 16 shows a plot of the mean DSC plasma thermogram from each disease category, as well as an average normal control DSC plasma thermogram from a database, in accordance with various embodiments;

FIG. 17 shows a plot of the mean DSC plasma thermogram from each disease category along with the mean normal control DSC plasma thermogram, in accordance with various embodiments;

FIG. 18 shows a comparison with previous data from RA and SLE disease categories that were compared to data in the database from previously collected samples, where mean DSC plasma thermograms from each set were found to be remarkably consistent for each disease category, in accordance with various embodiments;

FIG. 19 shows the risk assessment status indicator of 24 samples, in accordance with various embodiments;

FIG. 20 shows pattern recognition for samples that are similar to normal control reference samples, in accordance with various embodiments;

FIG. 21 shows pattern recognition for samples that are similar to SLE reference samples, in accordance with various embodiments;

FIG. 22 shows pattern recognition for samples that are not similar to normal or SLE reference samples, in accordance with various embodiments;

FIG. 23 shows the natural clustering of inflammatory and non-inflammatory DSC plasma thermograms, in accordance with various embodiments;

FIG. 24 illustrates that standard deviations for the non-inflammatory DSC plasma thermograms are greater than for the inflammatory DSC plasma thermograms, in accordance with various embodiments;

FIG. 25 shows a comparison of DSC plasma thermograms for inflammatory diseases with DSC plasma thermograms for other diseases, in accordance with various embodiments;

FIG. 26 shows a comparison of three unclassified DSC plasma thermograms, in accordance with various embodiments;

FIG. 27 shows a comparison of DSC plasma thermogram profiles that are consistent with a clinical classification of inflammatory versus non-inflammatory disease, in accordance with various embodiments;

FIG. 28 shows a summary of normal control references, inflammatory disease references, and inflammatory disease samples, in accordance with various embodiments; and

FIG. 29 illustrates a case study of POEMS syndrome indicating that DSC plasma thermograms may be used to successfully monitor disease progression and treatment outcomes, in accordance with various embodiments.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “NB” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous.

As used herein, the term “inflammatory disease” refers to a large group of diseases characterized by abnormal inflammation. The immune system is frequently involved in inflammatory diseases, with many immune system disorders resulting in inflammation. For the purposes of this disclosure, the term “inflammatory disease” refers to such disorders of the immune system, but excludes other diseases which may involve an inflammatory component, but that are not mediated by the immune system. Specific examples of such diseases that are not encompassed by the term “inflammatory disease” as used herein include cancer, atherosclerosis, ischemic heart disease, and Lyme disease. Examples of specific disease that are encompassed by the term “inflammatory disease” as used herein include asthma, autoimmune diseases, glomerulonephritis, inflammatory bowel disease, pelvic inflammatory disease, sarcoidosis, vasculitis, and transplant rejection.

As used herein the term “autoimmune disease” refers to those diseases that are commonly associated with the nonanaphylactic hypersensitivity reactions (e.g., Type II, Type III and/or Type IV hypersensitivity reactions) that generally result as a consequence of the subject's own humoral and/or cell-mediated immune response to one or more immunogenic substances of endogenous and/or exogenous origin. Such autoimmune diseases may be distinguished from diseases associated with the anaphylactic (Type I or IgE-mediated) hypersensitivity reactions. Specific, non-limiting examples of autoimmune diseases (or an “autoimmune disease category”) include celiac disease, diabetes mellitus type 1 (“IDDM”), systemic lupus erythematosus (“SLE”), Sjögren's syndrome, Churg-Strauss Syndrome, Hashimoto's thyroiditis, Graves' disease, scleroderma, idiopathic thrombocytopenic purpura, rheumatoid arthritis (“RA”), myositis, polymyositis, and multiple sclerosis (MS), as well as autoimmune hemolytic anemia, autoimmune atrophic gastritis of pernicious anemia, autoimmune encephalomyelitis, autoimmune orchitis, Goodpasture's disease, autoimmune thrombocytopenia, sympathetic ophthalmia, myasthenia gravis, Graves' disease, primary biliary cirrhosis, chronic aggressive hepatitis, ulcerative colitis, membranous glomerulopathy, Reiter's syndrome, polymyositis-dermatomyositis, systemic sclerosis, polyarteritis nodosa, bullous pemphigoid, or a combination thereof.

As used herein, the term “systemic lupus erythematosus (SLE)” refers to a clinically heterogeneous disease characterized by the presence of auto-antibodies directed against nuclear antigens. SLE is a multi-system disease, and subjects can present in vastly different ways. Prevalence varies with ethnicity, but is estimated to be at over 100 per 100,000 in the US. Over 90% of subjects with SLE have positive anti-nuclear antibodies (“ANA”). SLE is often difficult to diagnose and is frequently misdiagnosed as MS or RA, and diagnosis is difficult due to the lack of a single definitive test.

As used herein, the term “rheumatoid arthritis (RA)” refers to a chronic inflammatory disease characterized by uncontrolled proliferation of synovial tissue and a wide array of multisystem co-morbidities. The prevalence of RA is approximately 10 per 100,000 in the U.S., and RA is responsible for an estimated 250,000 hospitalizations and 9 million physicians' visits each year. Complications of RA may begin to develop within months of presentation; therefore, early, accurate diagnosis and consultation with a rheumatologist for initiation of treatment with disease-modifying anti-rheumatic drugs is critical. Although laboratory testing and imaging studies can help confirm a diagnosis and track disease progress, RA is primarily diagnosed clinically, and no single diagnostic test is available.

As used herein, the term “scleroderma” refers to a chronic, degenerative set of related disorders characterized by fibrosis (an excessive accumulation of tissue) and inflammation. Scleroderma may be disfiguring, debilitating, and deadly; in the most serious cases, the disease causes severe damage and severe complications for the body's digestive, respiratory, and circulatory systems. Scleroderma is a relatively rare condition, affecting between approximately 250,000 and 992,500 people in the U.S. Because the symptoms of scleroderma can vary in severity and type, a definitive, positive diagnosis can be difficult, especially in the early stages of the disease. Many symptoms are common to other diseases, especially other connective-tissue diseases such as RA, SLE, and PM.

As used herein, the term “myositis” is used to describe a number of inflammatory myopathies including dermatomyositis, inclusion-body myositis, juvenile forms of myositis, and polymyositis (PM). PM is a rare disease characterized by muscle inflammation and weakness, most noticeably weakness of the skeletal muscles. In the U.S., an estimated five to 10 out of every million people are diagnosed with one of the forms of PM every year. Diagnosis of PM can often be a lengthy process and typically includes MRI imaging tests, electromyography, muscle biopsy, and muscle enzyme and autoantibody blood tests.

As used herein, the term “multiple sclerosis (MS)” refers to an autoimmune disease that affects the brain and spinal cord. About 350,000 of approximately 2.5 million sufferers worldwide live in the U.S. In MS, hard scar tissue replaces the myelin sheaths of neurons, which results in disruption of nerve impulses. The condition is progressive and degenerative. Symptoms of MS may vary, and the disease is often misdiagnosed. While there is no cure, treatment may include corticosteroids, beta interferons, and/or tizanidine hydrochloride.

As used herein, the term “differential scanning calorimetry” or “DSC” refers to a thermoanalytical technique in which the difference in the amount of heat required to increase the temperature of a sample and a reference is measured as a function of temperature. Without being bound by theory, it is believed that both the sample and the reference are maintained at nearly the same temperature throughout the reading. Generally, the temperature program for a DSC analysis is designed such that the sample holder temperature increases linearly as a function of time. The reference sample generally has a well-defined heat capacity over the range of temperatures to be scanned.

As used herein, the terms “neoplastic disease” and “cancer” refer to a class of diseases in which a group of cells display uncontrolled growth, invasion that intrudes upon and destroys adjacent tissues, and sometimes metastasis, or spreading to other locations in the body via lymph or blood. These three malignant properties of cancers differentiate them from benign tumors, which do not invade or metastasize.

Cancers may be divided into types, including carcinomas, sarcomas, lymphomas, germ cell tumors, and blastomas, and may affect virtually any part of the body. Specific, non-limiting examples of cancers include cervical cancer, breast cancer, skin cancer (for example melanoma), lung cancer, oral cancer, brain cancer, ovarian cancer, uterine cancer, endometrial cancer, prostate cancer, bone cancer, leukemia, liver cancer, pancreatic cancer, colon cancer, stomach cancer, and bladder cancer.

As used herein, the terms “biological fluid” or “body fluid” include blood, plasma, cerebral spinal fluid (“CSF”), urine, vomit, cerumen (earwax), gastric juice, breast milk, mucus (including nasal drainage and phlegm), saliva, sebum (skin oil), semen, sweat, tears, and vaginal secretions.

As used herein, the term “Kendall's Tau Correlation” denotes the statistical terms related to the Kendall rank correlation coefficient, commonly referred to as Kendall's tau (τ) coefficient, which is a statistic used to measure the association between two measured quantities. A tau test is a non-parametric hypothesis test that uses the coefficient to test for statistical dependence.

As used herein, the term “signature thermogram” denotes a protein composition pattern for a sample obtained from a subject, and is generally compared to a standard thermogram.

As used herein, the term “standard thermogram” denotes either a negative standard thermogram containing a protein composition pattern associated with an absence of the condition of interest, or a positive standard thermogram containing a protein composition pattern associated with a presence of the condition of interest.

As used herein, the term “Spearman's rho” denotes a rank correlation coefficient, often denoted by the Greek letter ρ (rho) or as rₛ, and is a non-parametric measure of statistical dependence between two variables. Spearman's rho may be used to assess how well the relationship between two variables can be described using a monotonic function. If there are no repeated data values, a perfect Spearman correlation of +1 or −1 occurs when each of the variables is a perfect monotone function of the other.

As used herein, the term “Pearson's chi-square (X²) test” denotes a statistical procedure, the results of which are evaluated by reference to the chi-square distribution. A Pearson's chi-squared test may be used in contexts where it is important to make a distinction between a test statistic and its distribution.

As used herein, the term “heat capacity” denotes thermal capacity (usually denoted by “C” and often with subscripts), and refers to the measurable physical quantity that characterizes the amount of heat required to change a substance's temperature by a given amount. In the International System of Units (SI), heat capacity is expressed in units of joules per Kelvin. Derived quantities that specify heat capacity as an intensive property, independent of the size of a sample, are the molar heat capacity, which is the heat capacity per mole of a pure substance, and the specific heat capacity, often simply called specific heat, which is the heat capacity per unit mass of a material heat capacity values

As used herein, the term “quantiles” denotes points taken at regular intervals from the cumulative distribution function (CDF) of a random variable. Dividing ordered data into q essentially equal-sized data subsets is the motivation for q-quantiles, the quantiles are the data values marking the boundaries between consecutive subsets. Put another way, the k^{th} q-quantile for a random variable is the value x such that the probability that the random variable will be less than x is at most k/q, and the probability that the random variable will be more than x is at most (q−k)/q. There are q−1 of the q-quantiles, one for each integer k satisfying 0<k<q.

As used herein, the term “DSC plasma thermogram” is interchangeable with the terms Plasma Thermogram™ and LBIdx™ Plasma Thermogram™ DSC plasma thermograms provide a measurement that may be used to assess concentrations and conformations of dominant constituents of blood plasma or serum. The basis of the technology is the temperature-induced denaturation profile of the milieu of proteins within the blood plasma as measured by DSC. Such profiles may be used as indicators of particular disease states.

In various embodiments, methods, apparatuses, and systems for identifying inflammatory diseases are provided. In exemplary embodiments, a computing system may be endowed with one or more components of the disclosed apparatuses and/or systems, and may be employed to perform one or more methods as disclosed herein.

Disclosed herein in various embodiments are systems for identifying a biological fluid having an attribute of at least one inflammatory disease. In various embodiments, the system may generate and detect a plurality of heat capacity values from the biological fluid over a range of temperatures in order to generate a differential scanning calorimetry (DSC) thermogram data set. In various embodiments, DSC may be used to generate and detect a series of heat capacity values, and in some embodiments, the DSC device may be in signal communication with a computing system having software configured to align spatial distance similarities and shape correlation similarities between the test sample DSC thermogram data set and a reference DSC thermogram data set. In various embodiments, test sample DSC thermogram data sets that fall inside the quantile boundaries of the reference DSC thermogram data set may be grouped into a positive inflammatory disease category. In various embodiments, the reference database of heat capacity values of biological fluids may be constructed from values obtained from healthy (normal control) individuals or non-healthy individuals, such as individuals having a particular inflammatory disease or condition. Additionally, in various embodiments, simulations of diseased and healthy (normal control) status may be compiled, configured, and used in a database as a positive or negative reference. One of skill in the art will recognize that in various embodiments, a negative reference may be one that is associated with the absence of an inflammatory disease, and a positive reference may be one that is associated with the presence of an inflammatory disease in general, or with a specific inflammatory disease in some embodiments.

In some embodiments, when a test sample DSC thermogram data set is determined to be either positive or negative, the system may be configured to alert a user, for example by a signal from the computing system such as an indicator light, sound, signal on a monitor, printout, electronic message, or the like.

In various embodiments, any DSC may be used to carry out the method, for instance a GE MicroCal DSC, a TA Instruments DSC, a Perkin Elmer DSC, or the like. One of ordinary skill in the art will recognize that the computing system may use software that may enable database creation and database comparison tools, and substitutions of software that is functionally equivalent is considered to be within the spirit and scope of the disclosure. DSC is discussed at greater length below.

Also disclosed herein is a method of categorizing a biological fluid into an inflammatory disease category. Various embodiments of the method may include heating a biological fluid over a range of temperatures using a DSC to generate a plurality of heat capacity data values, and forming a test sample DSC thermogram data set from the plurality of heat capacity data values. In various embodiments, spatial distance similarity values and shape correlation similarity values may be calculated using the reference DSC thermogram data set as described above. In various embodiments, the test sample DSC plasma thermogram may align in both spatial distance and shape correlation within quantile boundaries of a reference sample DSC thermogram data set. In these examples, the test sample may then be categorized as having all or some of the same inflammatory disease attributes (or lack thereof, for a negative control) as the reference sample DSC plasma thermogram data set. In some embodiments, such as when a biological fluid sample is categorized as belonging in an inflammatory disease category, the system may be configured to alert a user as described above in greater detail.

Further embodiments include a method for monitoring an inflammatory disease in a subject. In some embodiments, the method may be a method of monitoring the efficacy of a therapy, such as a corticosteroid, probiotic therapy, helminthic therapy, or the like. In various embodiments, the method may include collecting a body fluid sample from the subject at a first time point, and generating a signature thermogram using a DSC. In various embodiments, by correlating the signature DSC thermogram to a standard DSC thermogram for the purpose of assigning the signature DSC thermogram as a positive match for the inflammatory disease, or for the purpose of assigning the signature DSC thermogram as a negative match for the inflammatory disease, a baseline DSC thermogram may be generated for the subject.

In various embodiments, the standard thermogram may include a negative standard DSC thermogram pattern associated with an absence of the inflammatory disease, or a positive standard DSC thermogram pattern associated with a presence of the inflammatory disease. In some embodiments, the inflammatory disease status of the subject may then be monitored by collecting a second body fluid sample from the same subject at a second time point and repeating the steps needed to generate a second signature DSC thermogram. In accordance with various embodiments, by comparing the first and second signature DSC thermograms, the inflammatory status of the subject, disease progression, or efficacy of a therapy may be monitored over time.

Also disclosed herein in various embodiments are systems for identifying a biological fluid having an attribute of at least one neoplastic disease. In various embodiments, the system may generate and detect a plurality of heat capacity values from the biological fluid over a range of temperatures in order to generate a differential scanning calorimetry (DSC) thermogram data set. In various embodiments, DSC may be used to generate and detect a series of heat capacity values, and in some embodiments, the DSC device may be in signal communication with a computing system having software configured to align spatial distance similarities and shape correlation similarities between the test sample DSC thermogram data set and a reference DSC thermogram data set. In various embodiments, test sample DSC thermogram data sets that fall inside the quantile boundaries of the reference DSC thermogram data set may be grouped into a positive neoplastic disease category. In various embodiments, the reference database of heat capacity values of biological fluids may be constructed from values obtained from healthy (normal control) individuals or non-healthy individuals, such as individuals having a particular neoplastic disease or condition. Additionally, in various embodiments, simulations of diseased and healthy (normal control) status may be compiled, configured, and used in a database as a positive or negative reference. One of skill in the art will recognize that in various embodiments, a negative reference may be one that is associated with the absence of a neoplastic disease, and a positive reference may be one that is associated with the presence of a neoplastic disease in general, or with a specific neoplastic disease in some embodiments.

Differential Scanning Calorimetry (“DSC”)

DSC is a thermoanalytical technique that may be used to determine the difference in the amount of heat required to increase the temperature of a sample and a reference, measured as a function of temperature, and is described in U.S. Pat. No. 3,263,484, which is incorporated by reference herein in its entirety. Briefly, the technique may include simultaneously applying heat to a sample material and a reference material. In various embodiments, as the sample material goes through various physical and chemical changes such as crystallization, melting, freezing, oxidation, etc., its temperature may be affected by the changes in internal energy. In various embodiments, the differences in temperature between the sample and reference may be recorded, and calculations may then be made for determining the internal energy changes occurring in the sample.

Generally speaking, when the sample undergoes a physical transformation such as a phase transition, more or less heat may need to flow to it than the reference in order to maintain both at the same temperature. Whether less or more heat must flow to the sample may depend on whether the process is exothermic or endothermic. For example, as a solid sample melts to a liquid, it may require more heat flowing to the sample to increase its temperature at the same rate as the reference. This is due to the absorption of heat by the sample as it undergoes the endothermic phase transition from solid to liquid. Likewise, as the sample undergoes an exothermic process (such as crystallization), less heat may be required to raise the sample temperature. In various embodiments, by detecting the difference in heat flow between the sample and the reference, differential scanning calorimeters may measure the amount of heat absorbed or released during such transitions. In some embodiments, DSC may also be used to observe subtler phase changes, such as glass transitions.

In various embodiments, both the sample and the reference may be maintained at nearly the same temperature throughout the procedure. Generally, the temperature program for a DSC analysis may be designed such that the sample holder temperature increases linearly as a function of time. In various embodiments, the reference sample may typically have a well-defined heat capacity over the range of temperatures to be scanned.

DSC Curves

In various embodiments, DSC may result in a curve of heat flux versus temperature or versus time. Generally speaking, there are two different conventions: exothermic reactions in the sample are observed with a positive or negative peak, depending on the kind of technology used in the experiment. In various embodiments, this curve may be used to calculate enthalpies of transitions. Although not wanting to be bound by theory, integrating the peak corresponding to a given transition may complete such calculations. The enthalpy of transition may be expressed using the following equation: ΔH=KA, wherein ΔH is the enthalpy of transition, K is the calorimetric constant, and A is the area under the curve. In various embodiments, the calorimetric constant may vary from instrument to instrument, and may be determined by analyzing a well-characterized sample with known enthalpies of transition.

DSC Plasma Thermograms

Various embodiments disclosed herein apply the DSC technique to plasma, for instance to produce DSC plasma thermograms that may be classified into databases that may be used to distinguish diseased DSC plasma thermograms from normal control DSC plasma thermograms. Many companies produce DSC machines or functional equivalents of DSC machines that may be used in the disclosed embodiments, such as GE MicroCal (22 Industrial Drive East, Northampton, Mass. 01060); TA Instruments (159 Lukens Drive, New Castle, Del. 19720); and Perkin Elmer (710 Bridgeport Avenue, Shelton, Conn. 06484), among others. Additionally, one of ordinary skill in the art will appreciate that other methods may be employed for measuring the heat capacity of a biological fluid at a given temperature. As such, devices, methods, or equivalents thereof that may be useful for measuring the heat capacity of a fluid over a range of temperatures are also contemplated, and fall within the spirit and scope of the present disclosure.

In order to understand how small variations in a complex composition may be used in various embodiments as comparative reference data sets, it is helpful to first understand how the same parameters may be affected when a pure substance is contaminated with other substances. Generally, forming a composition by mixing one or more elements with a pure element may alter the melting temperature, glass transition temperature, or crystallization temperature of the composition, as well as other chemical and physical characteristics. For example, alloys may have enhanced properties when compared to the pure substance (e.g., steel is stronger than iron). Unlike a pure substance, mixtures do not necessarily have a single melting point, but may have a melting range in which the composition is a blend of solid and liquid phases. This combination, in turn, may produce a unique melting point.

In an analogous fashion, a plasma DSC curve from normal control plasma (which may contain a mixture of over 3,000 proteins) may provide a unique signature when compared to a plasma DSC curve from an individual having a the same 3,000 proteins, plus compounds specifically related to the disease state of interest.

In various embodiments, a combination of one or more DSC plasma thermograms from individuals not expressing a disease of interest may be combined into a database representing an average global snapshot of the initial plasma proteome for a non-diseased state of a dynamic biological system. In contrast, in various embodiments, even minor changes in the dynamic system (e.g., expression of an oncogene) may cause molecular changes that may be visualized by comparing one or more global snapshot DSC plasma thermogram signatures from the non-diseased initial state with one or more global snapshot DSC plasma thermograms from a diseased state. More specifically, in various embodiments, a global snapshot of an individual's plasma protein fingerprint may reveal changes in one or more specific biomarkers. As such, in various embodiments, the DSC plasma thermogram may reflect global contributions of one or more biomarkers, thereby providing a comprehensive snapshot of an entire biological system.

In various embodiments, a DSC plasma thermogram may represent a composite melting curve of 3,000 or more proteins that make up the plasma proteome. Of these, only about 16 major blood proteins are present in a concentration sufficient for their melting curves to directly manifest in the DSC plasma thermogram, in accordance with various embodiments. Thus, in various embodiments, the complicated plasma mixture may be sensitive to interactions of one or more minor (or even undetectable) components found in circulating plasma (e.g., peptides, proteins, small molecules, phospholipids, or other entities). Without being bound by theory, in embodiments, these minor components may bind to or interact with one or more of the 16 major plasma proteins, which may alter one or more of the primary, secondary, tertiary, and/or quaternary structures. In various embodiments, the result may be a radical shift, in a mass weighted manner, in the DSC plasma thermogram fingerprint of an individual having a particular disease of interest, as compared to an individual not having the disease of interest. Thus, in various embodiments, DSC plasma thermograms may be sensitive to: a) the relative concentrations of the (approximately) 16 major plasma component proteins, some of which include HSA, transferrin, fibrinogen, and IGg, whose abnormal relative concentrations have been directly implicated in autoimmune diseases; and b) interactions with or between the approximate 16 major component proteins.

In various embodiments, the global signature yielded by DSC plasma thermograms may reflect the status of the whole dynamic biological system. Without being bound by theory, in various embodiments, a change in one or more DSC plasma thermograms may arise from an interaction between one or more disease specific biomarkers and one or more of the most abundant plasma proteins. In various embodiments, for healthy (normal control) individuals, DSC plasma thermograms may reflect a weighted sum of denaturation profiles (individual DSC plasma thermograms) for the most abundant constituent plasma proteins.

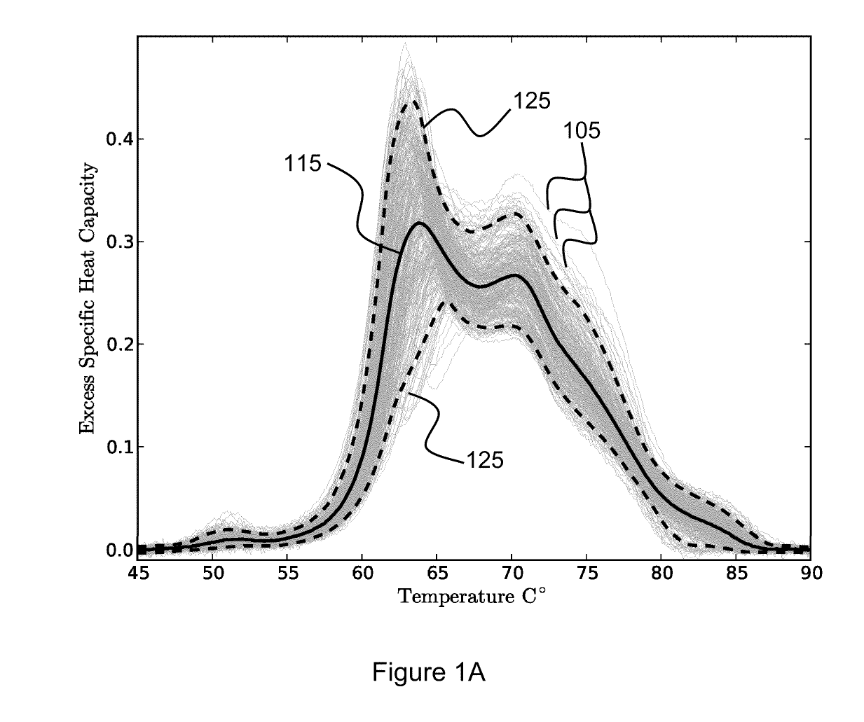

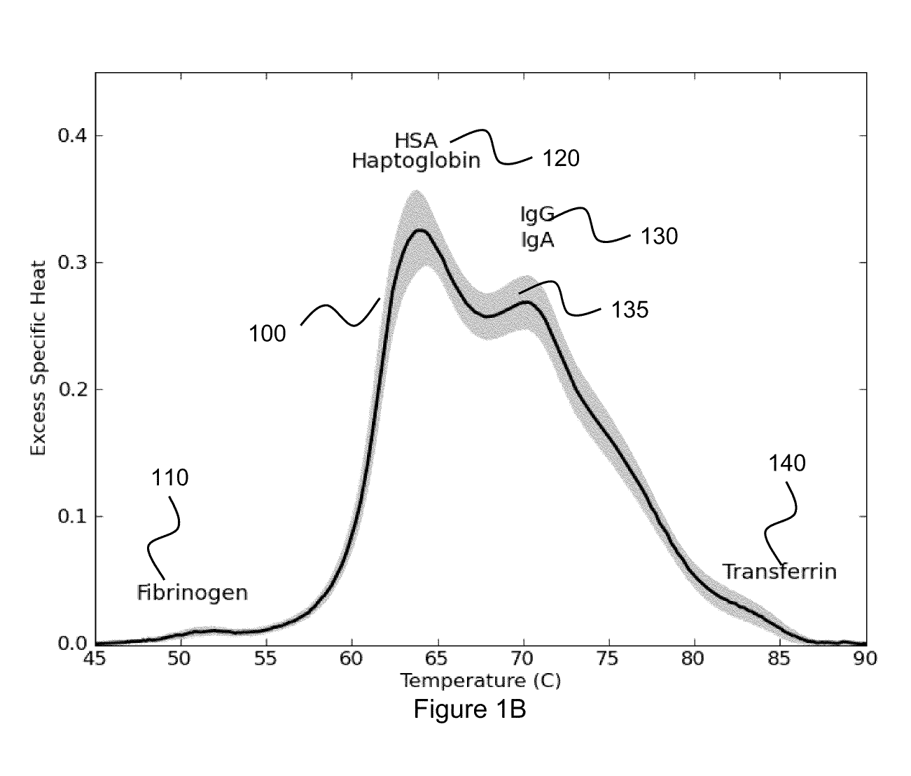

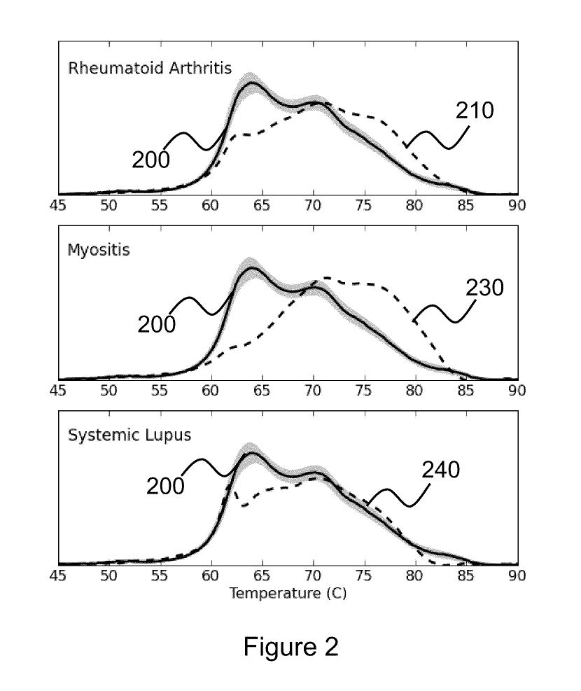

In one specific, non-limiting example, FIG. 1A shows over 500 DSC plasma thermograms collected from healthy (normal control) subjects, wherein the individual DSC plasma thermograms are represented as fine lines (105). The median DSC plasma thermogram is represented as a solid line (115), and the 90% quantiles are represented as dashed lines (125). An averaged DSC plasma thermogram from the healthy (normal control) individuals is shown as a dashed line (100), with the 90% quantiles represented as the shadowed area (135) in FIG. 1B. Regions on the DSC plasma thermogram that correspond to known protein components are indicated as fibrinogen (110), HSA/haptoglobin (120), IgG/IgA (130), and transferrin (140). In contrast, samples from diseased individuals show dramatically different signature profiles and each disease displays a distinctive and characteristic DSC plasma thermogram. As shown in FIG. 2, the averaged normal control DSC plasma thermogram is a solid line (200), and DSC plasma thermograms from diseased subjects are represented as dashed lines for RA (210), myositis (220), and SLE (230). Reproducible, distinct and characteristic DSC plasma thermograms have been measured for a number of disease states including cervical and lung cancer, leukemia, RA, SLE, Lyme disease, and amyotrophic lateral sclerosis.

DSC Plasma Thermogram Database Design

In various embodiments, the assemblage and normalization of DSC plasma thermogram data collected from subjects may be organized into a collection of data for one or more multiple use databases. One of ordinary skill in the will appreciate that there are many ways of classifying databases to involve different types of content (e.g., bibliographic, full-text, numeric, image, etc). Another classification method may begin by examining database models or database architectures, and more specifically, software that organizes the data in a database according to a database model. Yet other models such as the hierarchical model and the network model use a more explicit representation of relationships. In various embodiments, DSC plasma thermograms may be arranged into databases in different ways and yet still remain within the spirit and scope of the disclosure.

In various embodiments, although a DSC plasma thermogram autoimmune database design process may vary from the following steps, a general database design may include: determining the purpose of the DSC plasma thermogram database, finding and organizing the DSC plasma thermogram information that is required, dividing the DSC plasma thermogram information into tables, formatting the DSC plasma thermogram information items into columns, determining which DSC plasma thermogram information needs to be stored in each table, wherein each item becomes a field, and is displayed as a column in the table, specifying primary keys, setting up the table relationships, applying the normalization rules, and determining data to be stored.

In various embodiments, the process of applying the rules to a database design is referred to as normalizing the database or normalization. In various embodiments, normalization may be useful after all of the information items have been represented and a preliminary design has been selected, and may help ensure that the information items have been divided into the appropriate tables. Normalization cannot ensure that all the correct data items have been selected, however. By applying the rules in succession, each step may be checked to ensure that the design arrives at one of the five “normal forms.” In various embodiments, once the relationships and dependencies among the various pieces of information have been determined, the data may be arranged into a logical structure that may then be mapped into the storage objects supported by the database management system. In the case of relational databases, the storage objects may be tables that store data in rows and columns.

In various embodiments, each table may represent an implementation of either a logical object or a relationship joining one or more instances of one or more logical objects. In embodiments, relationships between tables may then be stored as links connecting child tables with parents. In various embodiments, since complex logical relationships are themselves tables, they may include links to more than one parent.

Generally, in an object database, the storage objects may correspond directly to the objects used by the object-oriented programming language used to write the applications that will manage and access the data. In embodiments, the relationships may be defined as attributes of the object classes involved, or as methods that operate on the object classes. In some embodiments, the physical design of the database may specify the physical configuration of the database on the storage media, including detailed specification of data elements, data types, indexing options, and other parameters residing in the DBMS data dictionary. In various embodiments, it is the detailed design of a system that includes modules and the database's hardware and software specifications of the system.

Statistical Analysis, Comparison, and Classification of DSC Plasma Thermograms

In accordance with various embodiments, melting curves of plasma from human blood measured by DSC plasma thermograms may be used to detect and/or diagnose human autoimmune diseases. In one specific, non-limiting embodiment, a general statistical methodology was developed to analyze DSC plasma thermogram data sets collected for human plasma. In various embodiments, the statistical metric may provide estimates of the likelihood that a particular DSC plasma thermogram belongs to a specific set of reference DSC plasma thermograms. In some embodiments, analysis of an acquired DSC plasma thermogram may involve comparison to a database of empirical reference sets of DSC plasma thermograms from clinically characterized diseases. In various embodiments, two parameters, a distance metric (P) and correlation coefficient (r), may be used to produce a combined ‘similarity metric’, p, which can be used to classify unknown DSC plasma thermograms into pre-characterized categories.

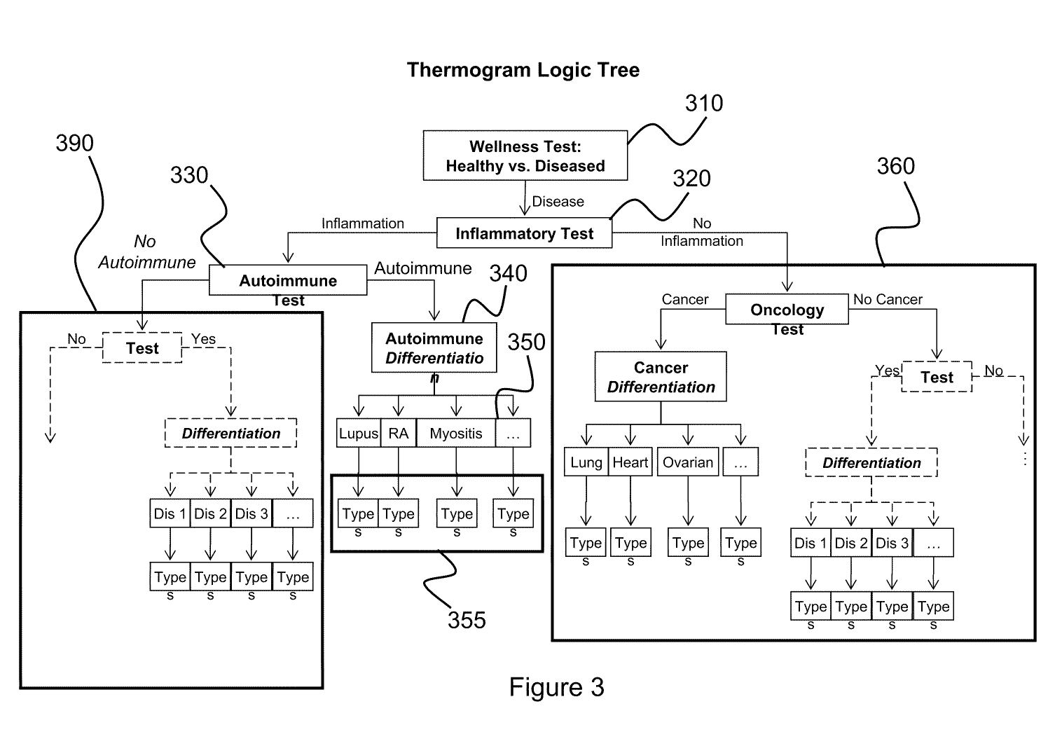

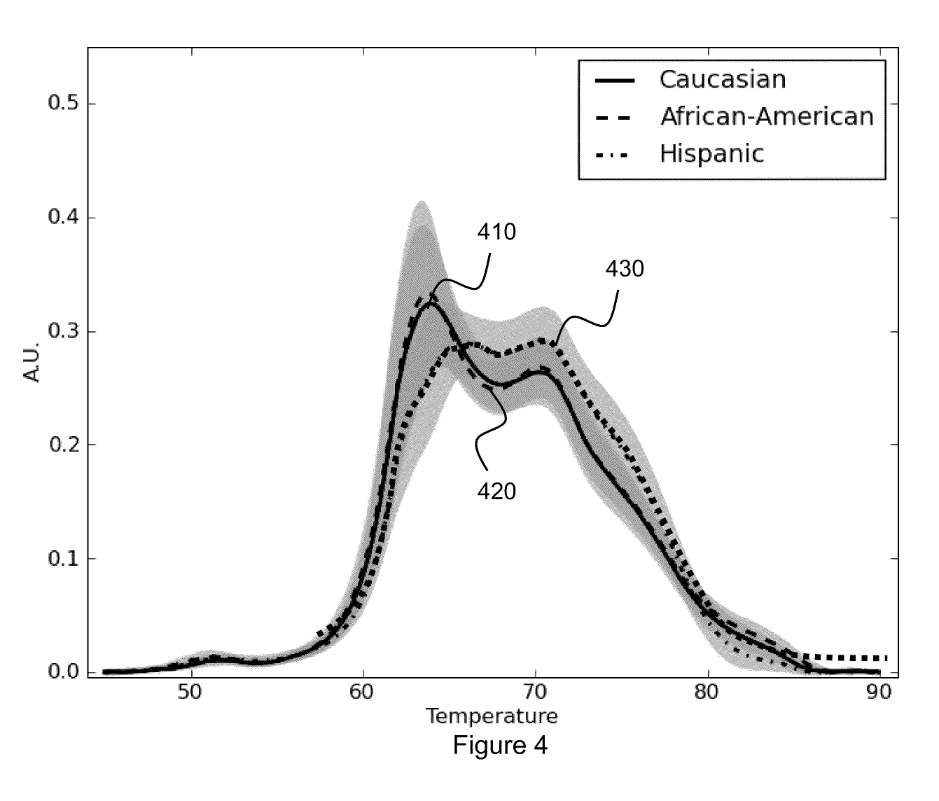

In one specific, non-limiting example, FIG. 3 shows a “thermogram logic tree” for the analysis and identification of inflammatory disease from specific types of DSC plasma thermogram databases. More specifically, (310) shows the logic point of healthy (normal control) vs. diseased, wherein a “diseased” positive DSC plasma thermogram may then be analyzed by an inflammatory test (320). In various embodiments, if a sample DSC plasma thermogram is grouped with inflammation, an autoimmune test (330) may be performed. In some embodiments, if autoimmunity is determined, autoimmune differentiation (340) may be further classified into categories for SLE, RA, myositis, and others (350), and further differentiation may be completed if needed and/or desired (355). In various embodiments, if the sample DSC plasma thermogram is not grouped with autoimmunity, other non-autoimmune/inflammatory positive tests (390) may be performed. Additionally, in some embodiments, if the sample DSC plasma thermogram is not grouped with inflammation, additional tests such as an oncology test (360) and/or further cancer differentiation tests may be used. Moreover, in various embodiments, the DSC plasma thermogram technology analysis may differentiate among various ethnic backgrounds, as shown in FIG. 4, which may also be useful for other branches of the DSC plasma thermogram logic tree

### EXAMPLES

The following examples are provided to further illustrate this disclosure and the manner in which it may be carried out. It will be understood by one of ordinary skill in the art, however, that the specific details given in the examples have been chosen for purposes of illustration only, and are not to be construed as limiting.

### Example 1

### Statistical Analysis of DSC Plasma Thermograms

In order to illustrate general properties of the systems and methods, simulated DSC plasma thermograms known to lie within or fall outside of the 90% quantile range around a median reference were analyzed. Results verified utility of the system and method, and established the apparent dynamic range of the metric p. The same methods were then applied to real data obtained for a collection of plasma samples from subjects clinically diagnosed with SLE. High correspondence was found between curve shapes and values of the metric p. In another application, an analytical routine of elementary classification rules was implemented to successfully analyze and classify unlabeled DSC plasma thermograms. These methods constitute a set of powerful yet easy to implement tools for quantitative classification, analysis and interpretation of DSC plasma melting curves.

As disclosed herein in various embodiments, DSC may provide a powerful diagnostic tool for the analysis of complex biological mixtures such as plasma from human blood. DSC measures the heat change of a sample as it is heated over a temperature range from ˜293K to 400K. Increasing the temperature of the biological fluid induces structural transitions in certain molecular constituents present in the fluid (e.g., proteins). Generally, a release (exothermic) or absorption (endothermic) of small amounts of heat accompanies these transitions. A DSC melting profile, or DSC thermogram, is a plot of the excess heat capacity, Cₚ^{ex}, as a function of temperature (T). As described herein in various embodiments, DSC analysis may be used to differentially distinguish human plasma samples from healthy (normal control) subjects (e.g., clinically non-symptomatic individuals) from subjects suffering from a variety of clinically diagnosed diseases and different types of cancer. As disclosed herein in various embodiments, DSC plasma thermograms of samples from clinically diagnosed subjects with RA, SLE, and Lyme disease are dramatically different from one another and from those derived from samples of clinically diagnosed ‘healthy’ (normal control) subjects.

In one specific, non-limiting example, DSC plasma thermograms representing over 2000 plasma samples, having at least 25 different diseases states, were recorded for analysis. Overall, the plasma DSC patterns have proven to be remarkably consistent and characteristic, and differences in curve shape are easily discernable in many embodiments. In contrast, other embodiments illustrate that subtle differences may be extracted using quantitative statistical methods. In various embodiments, to perform this analysis, a unique, nonparametric, quantitative, and reliable statistical scheme was developed to compare and classify DSC plasma thermograms according to their shapes and intrinsic patterns. In various embodiments, the statistical methods disclosed herein may perform several functions: (1) statistical characterization of large numbers of similar DSC plasma thermograms for use as comparative reference sets; (2) comparison of acquired DSC plasma thermograms (herein called ‘test’ curves) to sets of reference curves and quantitative determination of degree of similarity or difference between test and reference curves, and (3) classification of a test DSC plasma thermogram according to disease state.

In various embodiments, DSC plasma thermogram comparison methods were aimed primarily at addressing the diagnostic need, e.g., determining to what degree an unclassified test curve, xₜₑₛₜ(T), aligns with a given reference template curve, x_{ref}(T). In embodiments, the degree of similarity between a test curve and a reference DSC plasma thermogram may be characterized by two factors: (1) closeness in space (standardized Euclidean distance) at each temperature point, and (2) similarity in shape (correlation). In general, two DSC plasma thermograms may be highly correlated but, due to vertical scaling, may be separated by a nontrivial distance in space. Conversely, two DSC plasma thermograms may be spatially close, but poorly correlated due to fluctuations or noise in the data. For these reasons, in various embodiments, the metric employed to quantify similarities between test and reference curves may be a combination of both spatial distance and linear correlation.

In various embodiments, distance between two curves may be determined using a similarity index P(xₜₑₛₜ, x_{ref}, σ_{lower}, σᵤₚₚₑᵣ) defined as follows. At each temperature upper, T, the standardized distance between xₜₑₛₜ and x_{ref} is calculated as,

d(T)=abs[(xₜₑₛₜ(T)−x_{ref}(T))/σ_{ref}(T)],

where σ_{ref}(T)=x_{ref}(T)−σ_{lower}(T) if xₜₑₛₜ(T)<x_{ref}(T) and σ_{ref}(T)=x_{ref}(T)+σᵤₚₚₑᵣ(T) if xₜₑₛₜ(T)>x_{ref}(T).

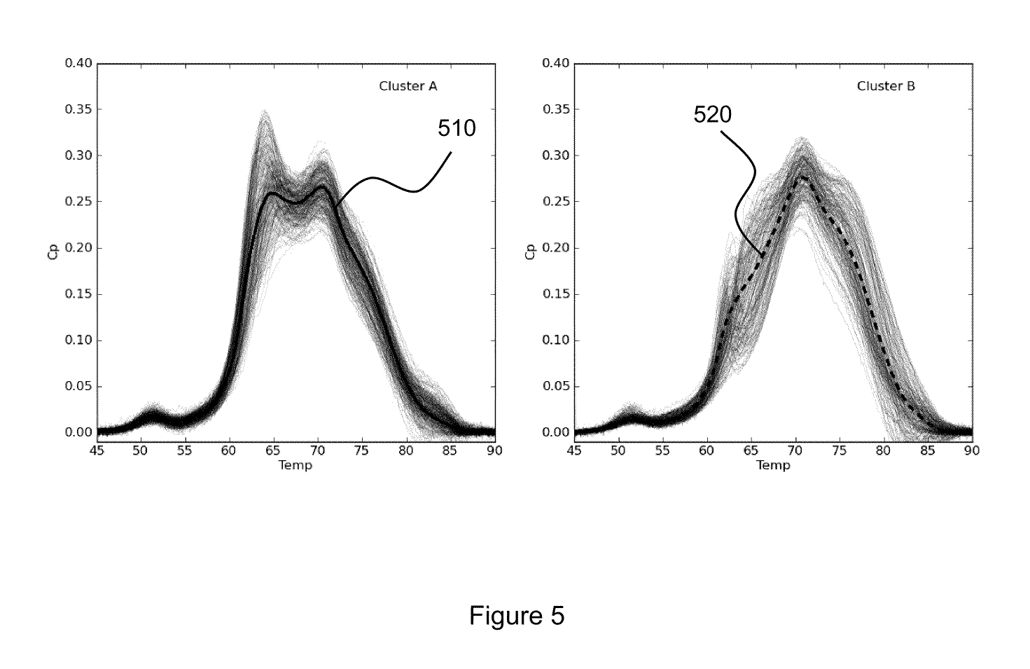

In embodiments, the standardized distance d(T) may be interpreted as the distance associated with a given reference data set that takes into account empirical distributions in the form of quantiles recorded for particular data sets (FIG. 5), wherein SLE versus normal control DSC plasma thermograms are shown. DSC plasma thermograms cluster naturally into two populations: normal control averages (e.g., cluster A, solid lines (510)), and SLE averages (e.g., cluster B, dashed lines (520)). The curves display over 300 DSC plasma thermograms from both populations.

In embodiments, a value of d(T)>1 indicates that, at the temperature T, the test curve is more distant from the median than 90% of the data in the reference set. If the specific form of the distribution is known, then d(T) may be interpreted as a z-score, and the probability distribution function representing the reference data may be used to compute critical values at each temperature. More generally, quantile boundaries are used as follows. At each temperature, define:

$$p ( T ) = \{ \begin{matrix}0.9 , & if d ( T ) \leq 1 \\ 0.1 , & if d ( T ) > 1\end{matrix}$$

The function p(T) returns high values (0.9) at temperatures for which the test curve falls within the quantile boundary, and returns low values (0.1) at temperatures for which the test curve falls outside the quantile boundary. Thus, in various embodiments, the function p(T) represents a likelihood, based on quantile values, that the test curve is similar to the reference set at each temperature point. No assumptions are made about the distribution of the reference DSC plasma thermograms. As a result, this choice of function may not be optimal for discrimination of test and template DSC plasma thermograms. In the case of a known distribution of reference curves, more appropriate forms of p(T), such as Gaussian or logistic functions may be employed.

In various embodiments, a scalar quantity representing similarity of the entire test curve to the reference set may then be computed as the arithmetic mean of p(T) over all temperatures (Tᵢ, i=1, 2, . . . . , n):

$$P = {\sum }_{i = 1}^{n} p ( {T}_{i} ) / n$$

In embodiments, the metric P may be interpreted as a probability determined by the standardized multivariate distance between the test curve and the reference template. A value of P near unity indicates the test curve is closer to the reference template than 90% of the reference data, while a value of P near zero indicates that the test curve is more distant than 90% of the data.

In various embodiments, similarity in shape between a test curve and the reference set may be quantified using a linear correlation, r, such as Pearson's or Kendall's tau correlation. Two DSC plasma thermograms that are linearly correlated necessarily possess similar shapes, so the linear correlation is an effective measure for discriminating between curves different shapes (assuming similar scaling of the data). In various embodiments, linear correlation may provide valuable information about the shape of test curves, and may help to support and strengthen conclusions about degrees of similarity between test and reference curves. Due to similarities in the overall protein composition of human blood plasma, any two DSC plasma thermograms will be highly correlated in certain temperature regions. For instance, in very low (20-50° C.) and very high (90-120° C.) temperature regions, major differences in DSC plasma thermogram shape are seldom found. As a result, the value of a linear correlation coefficient, r, between a test curve and a reference median curve will, in practice, never be negative, and will seldom even be close to zero. On an absolute scale, interpretation of r-values with regard to the strength of relationship on an absolute scale must be done with some amount of care. In practice, initial characterization of the data will help to determine significant levels of r for interpretive use. However, for the purposes of comparison of similar DSC plasma thermograms, the relative scale of r is more valuable, and can be established with training data and empirical calibration.

In various embodiments, a composite parameter, ρ, may then be introduced that combines the standardized distance function, P, and the correlation coefficient, r, into a single metric. That is,

ρ=(P·r)^{1/2}

In the unlikely case that r≦0, ρ is set to zero. The range of ρ is [0, 1], with values closer to zero indicating large differences in shape, and values approaching 1 indicating high similarity. In order to produce a high value of ρ, high values of both P and r are used, while a small value of either P or r alone is sufficient to produce a low ρ value. In various embodiments, the absolute scale for ρ may depend on the particular reference set (or sets) employed, and at this stage has not been generally established. Instead, a relative scale may be empirically determined based on the training data, and the metric may be calibrated before application to unknown test curves. The similarity metric, ρ, incorporates both distance and correlation into a single quantitative statistic that may then be used for discrimination between test curves and reference templates.

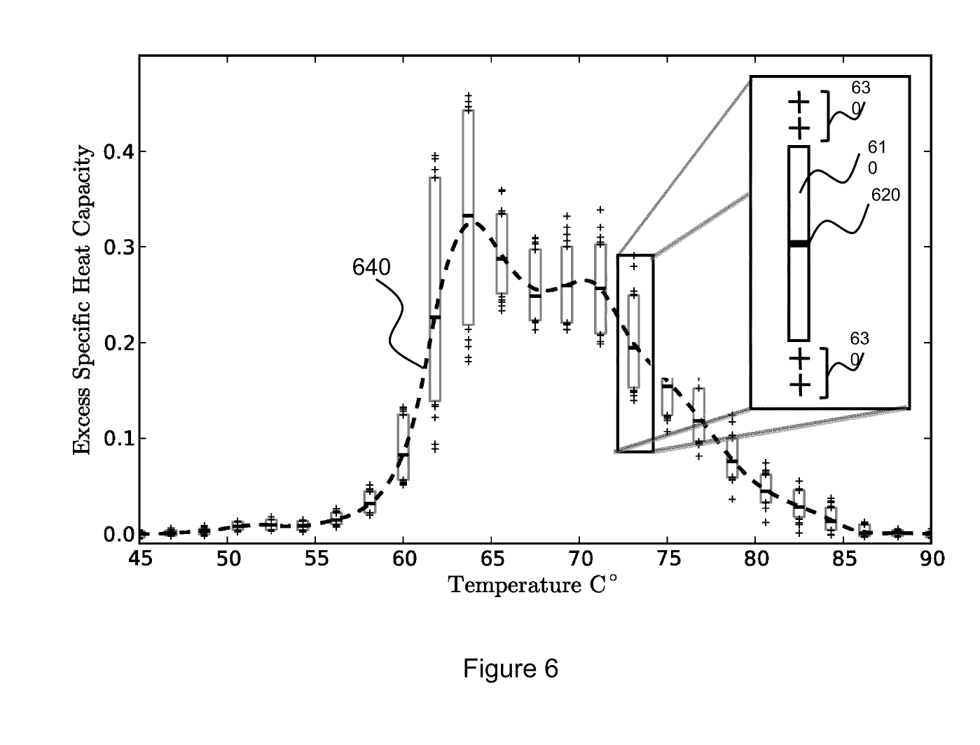

In accordance with various embodiments, to demonstrate application of our analytical methods, a set of 171 DSC plasma thermograms from samples clinically classified as ‘healthy’ (normal control) served as the healthy (normal control) reference set. Quantile boxes shown in FIG. 6 were constructed at a number of temperature points. Boxes (610) represent 90% quantiles ranging from 5-95%, while horizontal dashes (620) represent median values. Small crosses (630) indicate data points falling outside of the quantile range. The dashed curve (640) is the mean DSC plasma thermogram. For this set of DSC plasma thermograms, relatively little variance is observed in the lower (45-60° C.) and upper (80-90° C.) temperature ranges. In the central temperature region (60-80° C.), larger variability exists. Variations in the data may be visualized from a plot of the variance as a function of temperature. FIG. 6 shows that regions of low variance do indeed occur in the temperature ranges from 45-60° C. and 80-90° C. (average variance s²₍₄₅₋₆₀₎=4.85e-5 and s²₍₈₀₋₉₀₎=8.07e-5, respectively). Relatively higher variance is observed in the range from 60-80° C. (average variance s²₍₆₀₋₈₀₎=1.10e-3). The average variance over the entire temperature range was s²=0.0008.

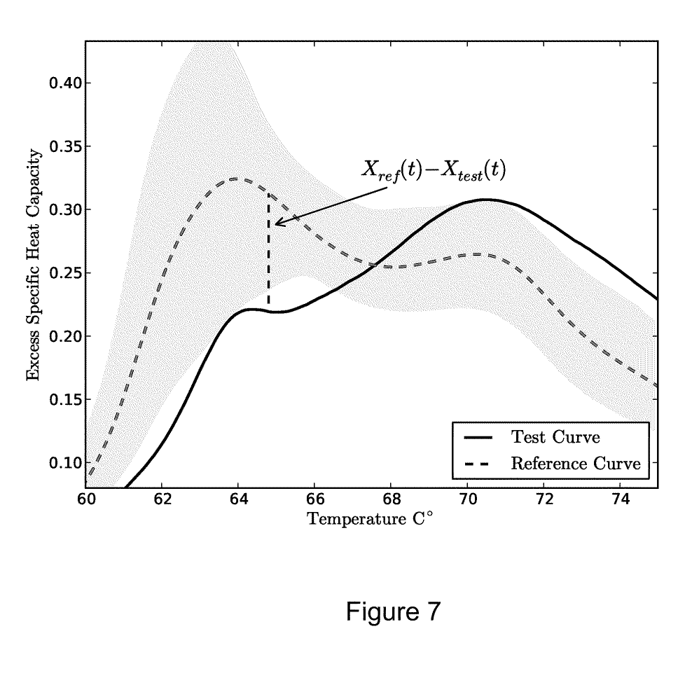

To determine the degree to which reference DSC plasma thermograms align with the median healthy (normal control) DSC plasma thermogram, the linear correlation between each reference curve and the median DSC plasma thermogram was computed for each reference curve in the set. The average coefficient over all curves was r_{avg}=0.971±0.028, which indicates very high levels of correlation between individual and median DSC plasma thermograms. This might reasonably be expected from a homogeneous population, and lends support for using healthy (normal control) DSC plasma thermograms as a reference set when classifying unknown DSC plasma thermograms (see, e.g., FIG. 7).

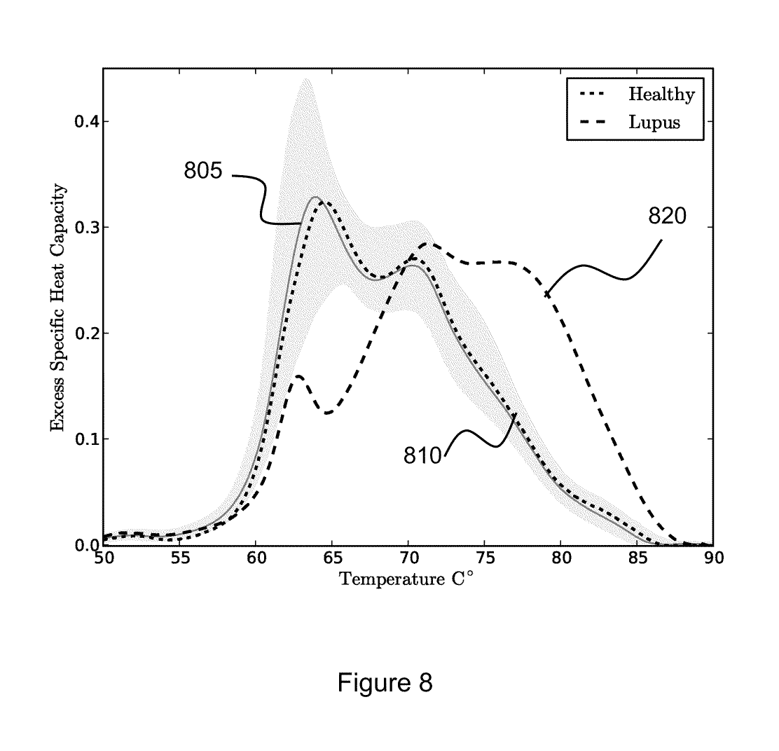

In one example, in order to demonstrate the efficacy of the analytical scheme, one DSC plasma thermogram from a healthy (normal control) subject was withheld from the original reference set, along with one DSC plasma thermogram from a subject with SLE, and both DSC plasma thermograms were compared to the reference set of healthy (normal control) DSC plasma thermograms. FIG. 8 illustrates that the test curve from the healthy (normal control) subject falls almost entirely within the 90% quantile bands. More specifically, FIG. 8 shows a comparison of healthy (normal control; 810; dotted curve) and SLE (820; dashed curve) DSC plasma thermograms to the reference median DSC plasma thermogram (805; solid curve). Shaded curves represent the 90% quantile band around the median. In fact, the largest distance between the sample curve and the reference DSC plasma thermogram was d(T)=1.16. Conversely, the SLE test DSC plasma thermogram fell significantly outside of the quantile band (205 out of 300 data points). Furthermore, the average distance from the SLE test curve to the median healthy (normal control) curve (d(T)=1.915) was larger than the maximum distance from the healthy (normal control) test curve to the median healthy (normal control) curve. The maximal distance from the SLE test curve to the median healthy (normal control) curve was d(T)=5.122.

Both graphical and numerical methods support the notion that the healthy (normal control) test curve may be classified as similar to the healthy (normal control) reference set while the SLE test curve can be classified as different. Quantitative evidence is provided by calculations of the similarity measures that yielded a value of P=0.828 for the healthy (normal control) test curve (a high value) and P=0.231 for the SLE test curve (a low value). A correlation value of r=0.991 was produced for the healthy (normal control) test curve and r=0.654 for the SLE test curve, and the composite ρ metric had values of ρ=0.906 for the healthy (normal control) curve and ρ=0.389 for the SLE curve. Based on this analysis, these two test curves may be considered to represent distinct disease states.

To illustrate the accuracy of these analytical methods, simulations of DSC plasma thermograms were performed. As a first approximation, DSC plasma thermograms were decomposed into weighted sums of Gaussian functions, which may be considered to be representative of ideal melting profiles of proteins. The amplitude of each Gaussian peak is proportional to the protein's concentration in solution and the location of the peak along the abscissa indicates its melting temperature. Individual protein concentrations and melting temperatures were varied systematically to simulate subtle changes to DSC plasma thermograms that are possible from the underlying constituent components. Random perturbations were made by altering peak amplitudes and abscissa locations of four Gaussian curves that are a sufficient number for a first approximation to a typical DSC plasma thermogram. In total, 600 DSC plasma thermograms were generated that fell into either of two categories defined by the 90% quantile ranges of the established healthy (normal control) and SLE reference sets.

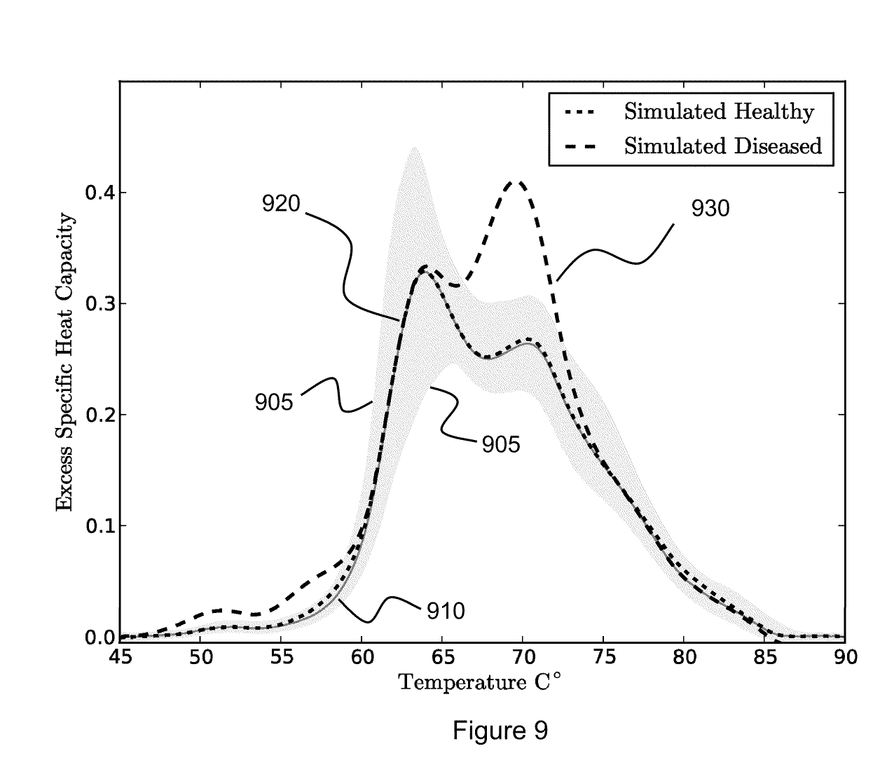

The first set of simulated DSC plasma thermograms included 300 curves generated by randomly selecting combinations of individual peak amplitudes so that the composite curve fell entirely within the 90% quartile range for the established healthy (normal control) reference DSC plasma thermograms. These curves are collectively referred to as ‘known similar’ since they were designed intentionally to be indistinguishable from healthy (normal control) reference curves. The second set of simulated DSC plasma thermograms included 300 curves falling outside the 90% quantile range. These curves are collectively referred to as ‘known different’. Average DSC plasma thermograms for both sets of simulated curves are shown in FIG. 9 where differences in simulated DSC plasma thermograms are clearly observable. More specifically, the 90% range (905), the reference curve (910), the simulated normal curve (920), and simulated diseased curve (930).

Each simulated DSC plasma thermogram was compared to the healthy (normal control) reference DSC plasma thermogram using the metrics described above. Average values of P=0.899 and r=0.999 were obtained for the ‘known similar’ set and average values of P=0.434 and r=0.799 were obtained for the ‘known different’ set, resulting in similarity values of ρ=0.9477 and ρ=0.5889, respectively (see Table 1). With these results as a guide, a range of ρ values may be determined to calibrate the metric and direct DSC plasma thermogram classification processes. From these simulations, a low value of ρ<0.6 would indicate a test curve is at least as different from the healthy (normal control) reference curve as the average simulated ‘known different’ DSC plasma thermogram. Conversely, a high value of ρ>0.8 would indicate a test curve is at least as similar to the healthy (normal control) reference DSC plasma thermogram as the average simulated ‘known similar’ DSC plasma thermogram.

TABLE 1
Values of P and r computed by comparison of simulated
thermograms to control reference set

| | P | r | p |
|---|---|---|---|
| Known Similar | 0.899 | 0.999 | 0.9477 |
| Known Different | 0.434 | 0.799 | 0.5889 |

Due to the simplified, ideal nature of these simulations, where variations in overall DSC plasma thermogram shape are due only to changes in concentration of a few major proteins, correlations of reference and test DSC plasma thermograms are not impacted drastically. A more sophisticated perturbation model that simultaneously considers factors like interactions with ligands that also shift locations of the known protein peaks along the abscissa, in addition to individual peak shape would result in a broader range of ρ values.

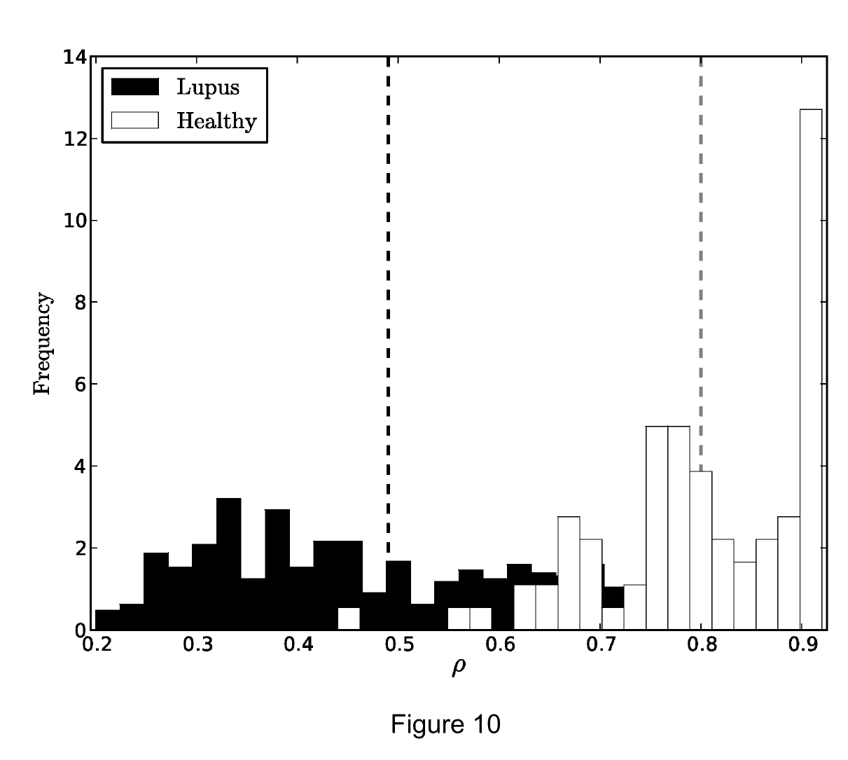

Healthy (normal control) versus SLE similarity measurements were computed for large sets of both healthy (normal control) and SLE DSC plasma thermograms. A collection of 196 healthy (normal control) DSC plasma thermograms not used to construct the healthy (normal control) reference set, and 200 DSC plasma thermograms from subjects clinically diagnosed with SLE were compared to the healthy (normal control) reference set. For each sample, the metric P and correlation coefficient r were determined and values of ρ were calculated. Histograms of resulting ρ values for both the healthy (normal control) and SLE populations are shown in FIG. 10, and show that the composite ρ metric captures average differences in curve similarity for each type of sample. A relatively low average value of ρ=0.407 that resulted for the SLE samples contrasted with the relatively high average value of ρ=0.712 calculated for the healthy (normal control) samples. Results are shown in Table 2.

TABLE 2
Values of P, r, and rho (p) computed by comparison of the healthy
(normal control) reference set with independent normal control
DSC plasma thermograms and DSC plasma thermograms
obtained from confirmed SLE subjects

| | Average P | Average r | Average ρ |
|---|---|---|---|
| Healthy | 0.679 | 0.782 | 0.720 |
| Lupus | 0.399 | 0.368 | 0.334 |

In various embodiments, when developing statistical methods for characterizing and classifying DSC plasma thermograms, the ultimate goal may be a quantitative (unsupervised) classification of unknown test DSC plasma thermograms into pre-characterized disease categories. As a demonstration of this application using the methods described above, a series of test curves was classified into one of two disease categories (healthy (normal control) vs. SLE) using standard classification techniques and the similarity index ρ.

Initially, a reference set of healthy (normal control) DSC plasma thermograms was characterized in order to extract mean and quantile vectors for use as a template that test curves are measured against. A similar analysis was performed on 171 SLE DSC plasma thermograms (the same set described above) to generate ‘SLE template’ mean and quantile vectors, or the SLE reference set. An additional 184 healthy (normal control) DSC plasma thermograms and 94 SLE DSC plasma thermograms not included in construction of the reference sets were then used as tests. Each test curve xₜₑₛₜ(T) was measured against both healthy (normal control) and SLE reference templates, and the similarity to each template was measured using the metric ρ, producing two values: ρ₁)xₜₑₛₜ)>ρ₂(xₜₑₛₜ), and ρ₂(xₜₑₛₜ), respectively. The following standard decision rule was then used to classify each test curve as either healthy (normal control) or SLE:

Rule 1: If ρ₁(xₜₑₛₜ)>ρ₂(xₜₑₛₜ), classify the test curve xₜₑₛₜ as ‘healthy’ (normal control), otherwise classify test curve xₜₑₛₜ as ‘SLE’.

That is, classify a test curve based on a comparison to whichever template is determined to be the most similar using the ρ metric. Application of this decision rule correctly classified 155 of the 184 (84.2%) known healthy (normal control) test curves and 77 of the 94 (81.9%) known SLE test curves, which is a considerable success for this simple metric. These values fall into a range that is entirely consistent with the current diagnostic standards for antinuclear antibody testing for SLE.

In various embodiments, the power of DSC plasma thermogram analysis and classification may lie in the categorization of DSC plasma thermograms according to shape and pattern, with the primary objective being the application of DSC in the diagnostic setting. In general, biological samples are inherently complex mixtures, and prior to this disclosure, few attempts have been made to address their collective melting behaviors. The ability to classify DSC plasma thermograms into distinct disease categories may be an indication that a common feature is responsible for observed shifts in DSC plasma thermogram profiles.

In various embodiments, DSC plasma thermograms may be sensitive to temperature dependent molecular transitions and/or chemical interactions between molecules that occur in solution. Such intra- and inter-molecular chemical binding events may result in microscopic production or loss of heat that the DSC instrument collectively detects. Thus, many diseases may be characterized by interactions of small circulating ligands with plasma proteins present in high concentrations (e.g., human serum albumin, IgG, transferrin, etc). Thus, many of these binding events may be responsible for variations in the shapes of DSC plasma thermograms. By binding specifically to proteins present in the sample, such ligands may act to shift the melting transition of one (or more) of the major protein peaks along the temperature axis. While substantial DSC plasma thermogram shifts are observed for some diseases, specific culprits responsible for the shifts may not be known.

In various embodiments, sophisticated theoretical models have been developed to help understand the melting process for homogeneous solutions of proteins or well-defined ligand/protein mixtures. In these models, closed-form equations describe reacting systems that contain both inter- and intra-molecular interactions (binding and melting, respectively). Although such physical models may provide powerful insights into the molecular constituents and interactions responsible for DSC plasma thermogram shifts, the idealized systems for which they have been developed may not take into account the possibility of multiplex reactions between elements of the ‘interactome’.

Alternative computational techniques are commonly employed for complex signal analysis. Many well-known analytical methods exist to identify and compare patterns and shapes of various curve forms. Such methods have been successfully applied to diverse problems in fields ranging from biostatistics and biochemistry to atmospheric physics, seismology, materials science, computer science, and optics. Although alternative analytical methods with similar capabilities may be employed, underlying assumptions and domain limitations (inherent or otherwise) often render these methods inappropriate or unnecessary for the specific analysis or classification of DSC plasma thermograms.

A number of detailed computational procedures, including learning algorithms such as neural networks or genetic algorithms, may be applied to the problem of curve pattern recognition. Likewise, statistical optimization techniques may address a wide range of pattern analysis tasks including density estimation, clustering, feature selection and classification, error estimation or dimensional reduction. Non-parametric curve matching methods utilize various distance functions (like Taxicab or Hausdorff distances) or probabilistic measures of similarity, not unlike those presented here, to classify curves and shapes of curves. Model-based curve matching techniques employ functional data analysis methods and employ numerical optimization routines to parameterize functional models to compare and classify curves and shapes. One of ordinary skill in the art is familiar with and understands classical fitting methods like the Kolmogorov-Smirnov, Cramer-von Mises, Chi-square, or Anderson-Darling tests that may be employed to quantify differences between data sets.

Sophisticated multivariate statistical methods developed for chemometric analysis, such as principal component analysis, partial least-squares regression and linear discriminate analysis, may be frequently employed for analysis and classification of data of the type presented here, in accordance with various embodiments.

Thus, DSC plasma thermogram analysis is a powerful tool for identifying perturbations in plasma composition. These perturbations are reflected in differences (either subtle or dramatic) in DSC plasma thermogram patterns. DSC plasma thermograms provide an orthogonal view to diagnostic detection based on concentration, mass, and thermodynamic stability that complements other commonly employed analytical techniques such as gel electrophoresis and mass spectrometry. These latter diagnostic techniques separate and characterize plasma components based on size (mass), shape and charge. Mass spectrometry is sensitive to both size and charge while protein electrophoretic migration can be sensitive to size, shape and charge. In contrast, DSC plasma thermograms may be derived from measurements of the heat generated or absorbed by the composite plasma solution as a function of temperature. Thus, DSC may provide a unique window into the plasma proteome.

Some embodiments of the statistical methods presented here have been developed for general descriptive analysis and classification of DSC plasma thermogram data according to curve shape. An advantage of these methods is that they are easy to understand and implement without the need of complex or expensive statistical software.

### Example 2

### Detection and Diagnosis of Autoimmune Diseases

Autoimmune diseases such as SLE, RA, scleroderma, PM, and MS, as well as the infectious disease Lyme disease are often very difficult to accurately diagnose. In particular, detection and diagnosis of these diseases relies on seropositive tests for antinuclear antibodies (ANA). Unfortunately, many subjects with positive ANA tests are incorrectly given a diagnosis of SLE or other disease, and are routinely and unnecessarily treated with toxic medications carrying their own set of health risks. Moreover, disease symptoms are often not apparent until the disease has reached a relatively advanced stage.

In various embodiments, DSC plasma thermogram technology may provide a new diagnostic platform for which to develop diagnostic assays for the differential diagnosis of autoimmune diseases. As illustrated in FIG. 2, in various embodiments, a comparison of RA (210), SLE (240) and myositis (230) DSC plasma thermograms measured for samples from subjects diagnosed with autoimmune diseases displayed in FIG. 2 demonstrate clear differences from healthy (normal control; 200) DSC plasma thermograms; as well as differences from each other (confirmed at a 99% confidence level by statistical analysis).

### Example 3

### Detection and Diagnosis of Neoplastic Diseases

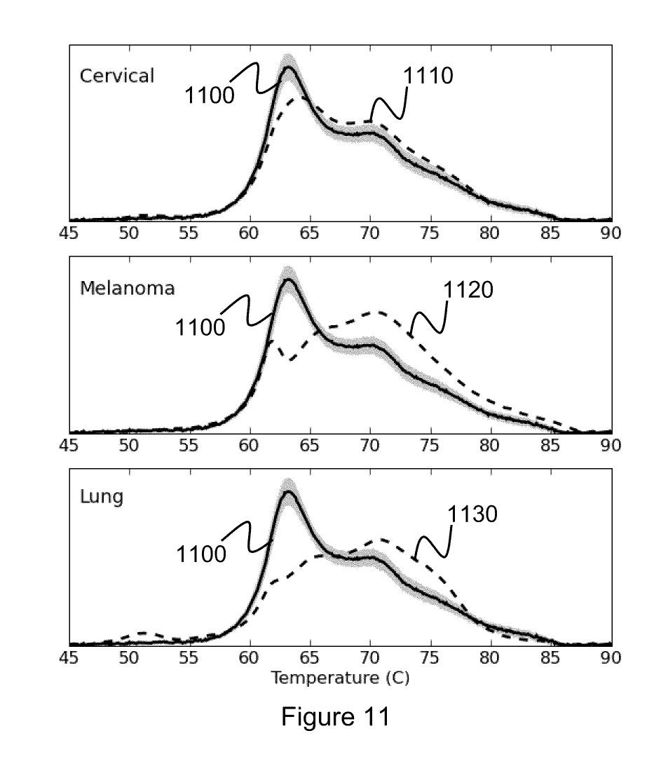

As illustrated above, DSC plasma thermograms from diseased individuals differ from healthy (normal control) DSC plasma thermograms. FIG. 11 shows DSC plasma thermograms obtained for samples from subjects with cervical cancer (1110), melanoma (1120) and lung cancer (1130). The illustrated DSC plasma thermograms are averages for at least 12 subjects diagnosed with the particular cancer. One striking feature of these curves is that they are all (statistically) significantly different from healthy (normal control; 1100) DSC plasma thermograms, and different from one another. Comparable results have also been obtained for a variety of other neoplastic diseases, including ovarian, uterine, and endometrial cancer.

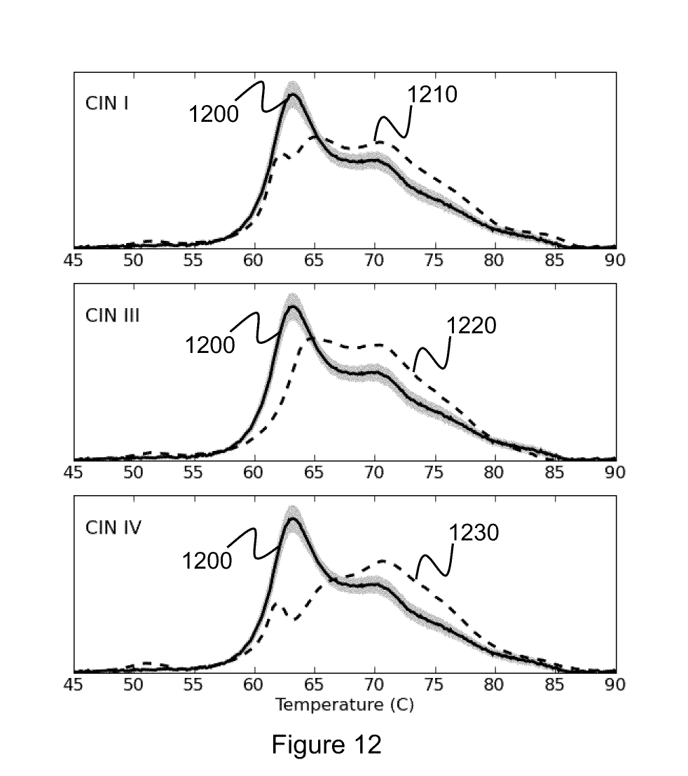

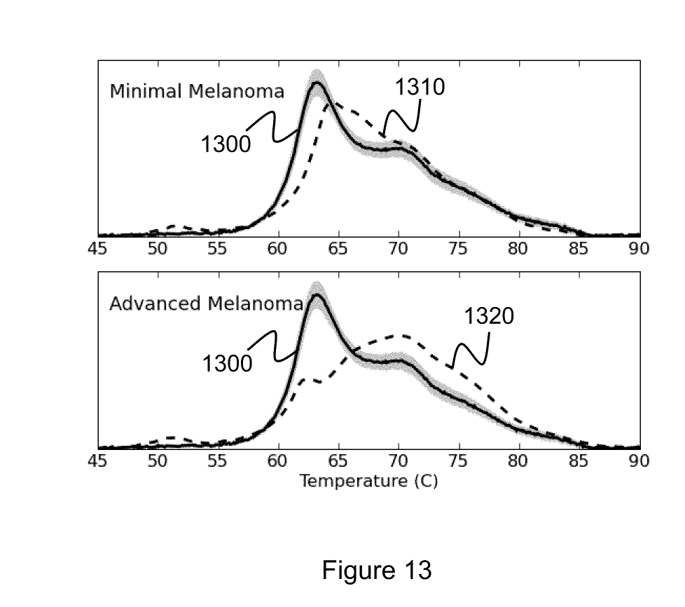

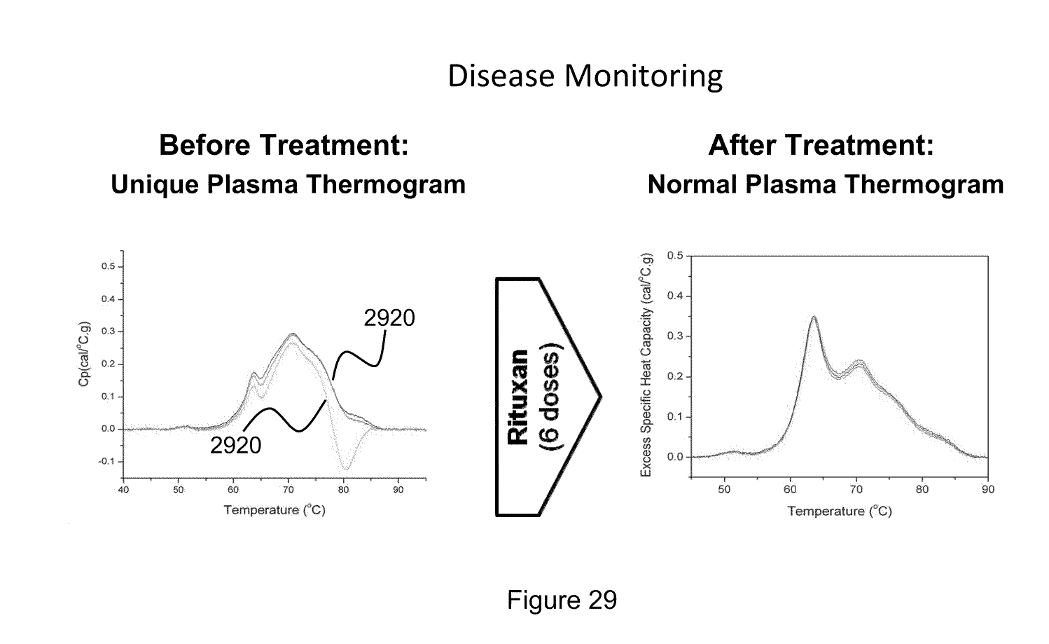

In further embodiments, unique DSC plasma thermograms display characteristic shapes associated with different stages for cervical cancer (FIG. 12) and melanoma (FIG. 13). FIG. 29 shows a case study of a subject with POEMS syndrome, indicating that DSC plasma thermograms may be used to monitor disease progression and treatment outcomes, since the “before treatment” curve shows a unique DSC plasma thermogram (2910) compared to a normal control DSC plasma thermogram (2920). After receiving 6 doses of Tituxan, the ‘after treatment’ DSC plasma thermograms looked like normal control DSC plasma thermograms. Additionally, the DSC plasma thermograms shown in FIG. 12, FIG. 13 and FIG. 29 demonstrate their ability to monitor disease progression and treatment progress. These results attest to the diagnostic and detection power of DSC plasma thermograms.

### Example 4

### Demographic DSC Plasma Thermogram Categories

In various embodiments, sets of normal control DSC plasma thermograms may be resolved into different demographic categories. In order to determine statistical differences between mean DSC plasma thermograms from each stated demographic category, ANOVA analysis was performed at each temperature point, and p-values for an “equal means” hypothesis were computed. Results confirmed statistically significant differences between mean DSC plasma thermograms from Hispanic subjects and those from Caucasian and African-American subjects. FIG. 4 shows stratification of normal control DSC plasma thermograms by ethnicity. The population of Hispanic DSC plasma thermograms (dashed dotted line) is significantly different from Caucasian (solid line) and African-American (dashed line) DSC plasma thermograms. A visual difference is apparent between Hispanic DSC plasma thermograms and both Caucasian and African-American DSC plasma thermograms, but visually, the DSC plasma thermograms from Caucasian and African-American samples are barely distinguishable. Results of statistical analysis confirm these observations. As shown in Table 3, significant differences (1−p>0.9) were found between Hispanic and both Caucasian and African-American mean DSC plasma thermograms. In contrast, no significant difference (1−p<0.9) was found between mean DSC plasma thermograms from African-American and Caucasian samples, as well as from male and female categories. Thus, in various embodiments, preliminary classification of samples by demographic category may reduce variability within sets of normal control DSC plasma thermograms, which may be used as reference sets in diagnostic procedures.

TABLE 3
Results of ANOVA analysis of demographic categories within
normal control thermograms. Values represent the probability
that the mean thermograms from each demographic category
are significantly distinct (1 − p).

| | | African- | |
|---|---|---|---|
| | Caucasian | American | Hispanic |
| Hispanic | 0.91 | 0.96 | 0 |
| African-American | 0.55 | 0 | |
| Caucasian | 0 | | |

Power analysis based on the standard error in each demographic category provided estimates on sample sizes that were used to distinguish disease DSC plasma thermograms from normal control DSC plasma thermograms, taking into account the observed ethnic stratification. In one specific, non-limiting example, based on the precision of DSC plasma thermogram measurements, it was determined that a relative standard error of 2% or less within each set of DSC plasma thermograms is sufficient to distinguish disease state through statistical comparison to the mean. In particular embodiments, corresponding sample sizes for each category range from 50-200.

In another example, over 600 de-identified plasma samples were procured from the Lupus Foundation Registry and Repository (Oklahoma City, Okla.) containing a large number of DSC plasma thermograms from two demographic categories (e.g., African-American and Caucasian), but only a few from the Hispanic category. Nearly half of the samples received were identified as negative SLE controls and assumed to be normal controls, and half were from subjects clinically diagnosed with SLE. Sample DSC plasma thermograms were collected and compared to the established set of normal control DSC plasma thermograms in the database. By stratifying the data into ethnic categories, the 600 acquired DSC plasma thermograms were classified using established comparison methods. Due to the small number of DSC plasma thermograms from the Hispanic demographic included in this data set, statistical measures did not improve significantly by comparisons with the mean Hispanic DSC plasma thermogram. However, the roughly 300 new normal control DSC plasma thermograms derived from subject samples provided with the SLE samples closely matched the normal control curves for Caucasians and African-Americans previously measured and analyzed.

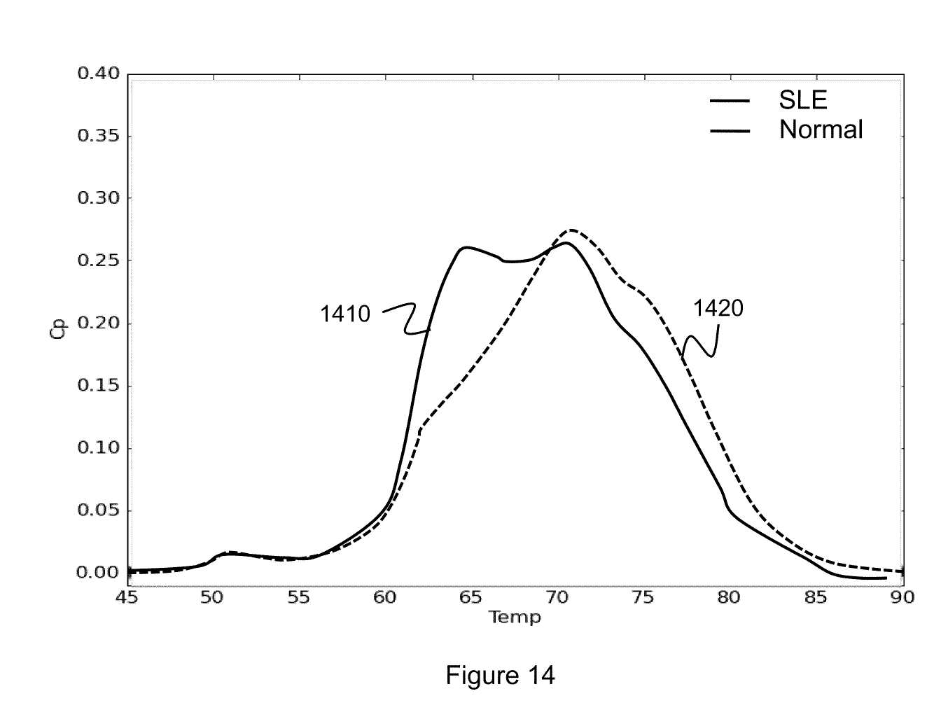

As shown in FIG. 14, cluster analysis indicated significant differences between the mean DSC plasma thermograms of SLE (1420) and normal control (1410) data sets. Ethnic stratification was not necessary since only diseased DSC plasma thermograms for African-American and Caucasian subjects were obtained. Simulated results demonstrated that impressive sensitivities and specificities 0.85) are achievable.

In another specific example, a comprehensive strategy was developed to organize and facilitate access to the generalized database of DSC plasma thermograms. To enable automatic storage and retrieval of DSC plasma thermograms, the collected DSC plasma thermogram data was organized according to unique identifiers. Organizing data by identifiers enables routines to call appropriate sets of DSC plasma thermograms for analytical comparisons. For instance, to analyze DSC plasma thermograms along ethnic lines, DSC plasma thermograms may be callable by routines according to Hispanic vs. non-Hispanic identifiers. In some embodiments, the data may be organized into finer categories prior to analytical activities, and the structure of the database may facilitate further organization of DSC plasma thermograms into subcategories of potential interest.

In embodiments, generalized search and compare methodologies may be used to rigorously compare measured DSC plasma thermograms to reference DSC plasma thermograms stored in the database based on machine learning and pattern recognition.

### Example 5

### Creation of a Sample Database

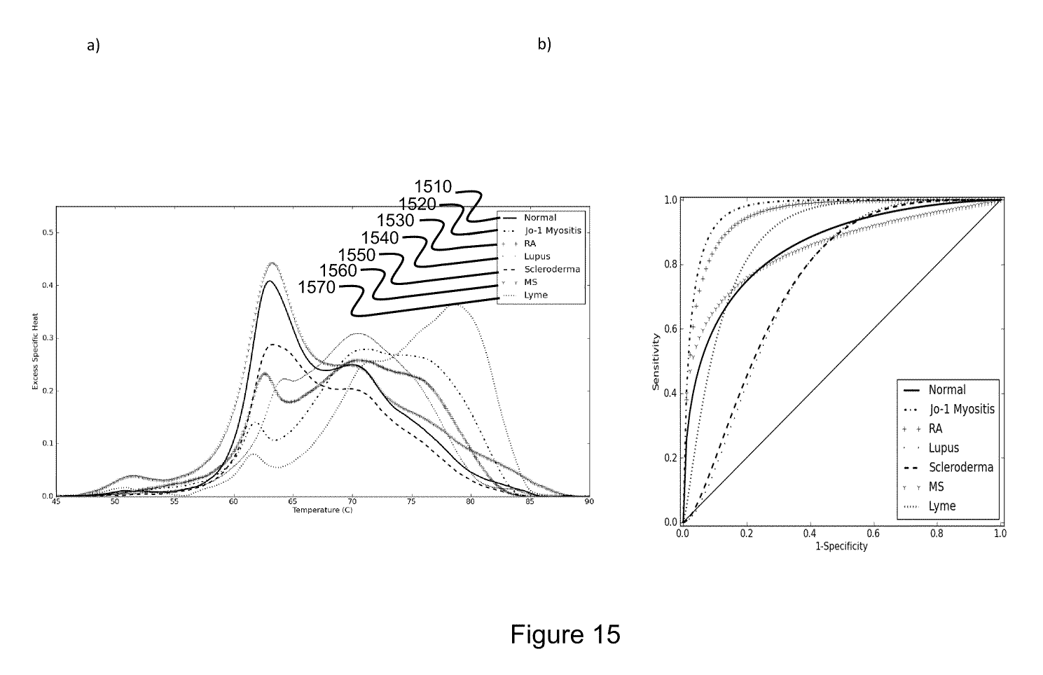

In another specific example, a prototype diagnostic assay was created based on the DSC plasma thermogram technology platform using over 650 SLE samples, 50 scleroderma samples, 18 RA samples, and 25 PM samples, as well as MS and Lyme disease samples. Effectiveness of the diagnostic was validated by first demonstrating differences in characteristic average DSC plasma thermograms for plasma samples obtained from individuals afflicted by the different diseases (see, e.g., FIG. 15A). Different average DSC plasma thermograms from each disease category indicate the compositions of samples are clearly different from each other. (e.g., normal control—1510; myositis—1520; RA—1530; SLE—1540; scleroderma—1550; MS—1560; Lyme—1570). A receiver operating characteristic (ROC) curve analysis illustrates that samples may be distinguished from each other in a statistically and clinically relevant manner. ROCS curves may provide a range of specificity and sensitivity values versus one another as a function of cutoff criterion, and indicate the trade off between specificity and sensitivity for the diagnostic.

In Table 4, displayed p-values indicate that each disease DSC plasma thermogram may be distinguished in a statistically meaningful manner from normal control DSC plasma thermograms and from each other. Thus DSC plasma thermograms provide a powerful diagnostic for discrimination of autoimmune diseases.

TABLE 4
Average p-values from ANOVA analysis of disease categories.

| | | | Sclero- | | | | |
|---|---|---|---|---|---|---|---|
| | Lyme | MS | derma | SLE | RA | Jo-1 PM | Normal |
| Normal | 0.97 | 0.86 | 0.99 | 0.92 | 0.95 | 0.98 | 0 |
| Jo-1 PM | 0.78 | 0.98 | 0.98 | 0.98 | 0.97 | 0 | |
| RA | 0.87 | 0.96 | 0.96 | 0.91 | 0 | | |
| SLE | 0.97 | 0.92 | 0.98 | 0 | | | |
| Scleroderma | 0.97 | 0.81 | 0 | | | | |
| MS | 0.97 | 0 | | | | | |
| Lyme | 0 | | | | | | |

Values represent the probability that the mean thermograms from each pair of disease states are significantly distinct

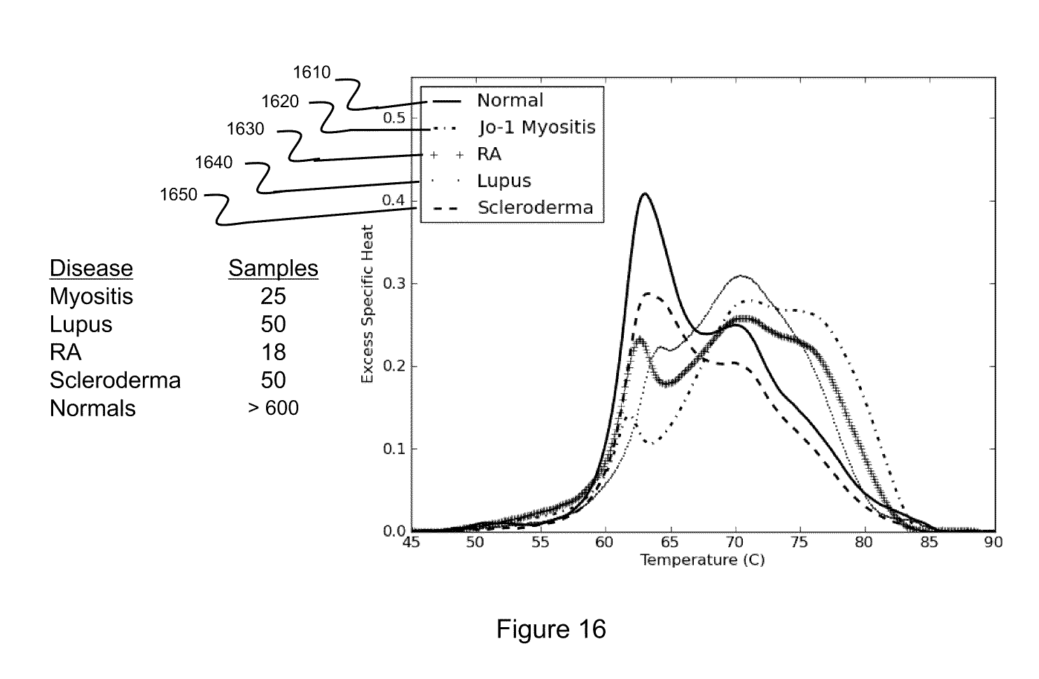

In various embodiments, the mean DSC plasma thermogram from each disease category may be used as a template against which unknown test curves may be tested. FIG. 16 shows a plot of the mean DSC plasma thermogram from each disease category, as well as the average normal control DSC plasma thermogram from the database described above. Each mean disease DSC plasma thermogram has a distinct pattern, with DSC plasma thermograms from Jo-1 myositis (1620) and RA (1630) showing the greatest differences from normal control (1610), wherein other diseases listed are SLE (1640) and scleroderma (1650).

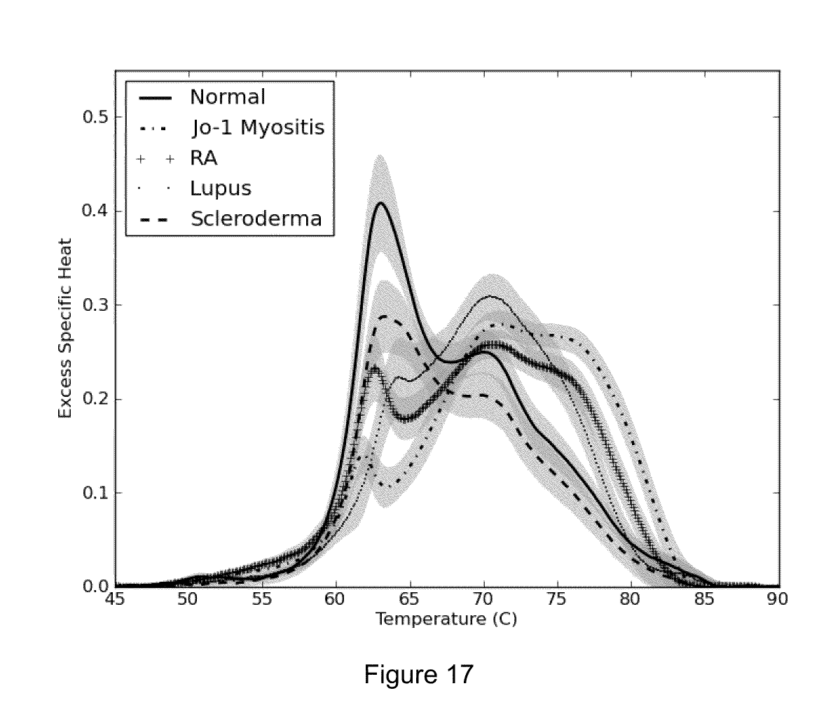

In various embodiments, in order to distinguish DSC plasma thermograms from different categories, small standard deviations, distinct mean curves, and relatively small variances of the data within each category maybe advantageous. FIG. 17 shows a plot of the mean DSC plasma thermogram from each disease category along with the mean normal control DSC plasma thermogram. Shaded regions represent one standard deviation around the mean.

One-way ANOVA was performed on data from each pair of disease categories to determine the probability that the mean DSC plasma thermograms from each set are significantly distinct. All pairs of disease categories were found to be significantly distinct with probability greater than 80% (see, e.g., Table 4). The relative standard error (RSE) for each data set was also calculated at each temperature point and the median RSE value was recorded. The RSE is a function of the variance of the set and the sample size, with low values indicating sufficient sample size for well-characterized data (e.g., precise estimate of the mean DSC plasma thermogram). RSE values for all disease categories were found to be well below acceptable industry standards of 10% (see, e.g., Table 5).

TABLE 5
Median relative standard error (RSE) for each disease category. Low
RSE values indicate sufficient sample size (N) for well-clustered data

| Disease | N | Median RSE |
|---|---|---|
| Normal | 171 | 1.7% |
| Jo-1 Myositis | 45 | 3.7% |
| RA | 29 | 5.6% |
| Lupus | 95 | 3.2% |
| Scleroderma | 91 | 3.0% |

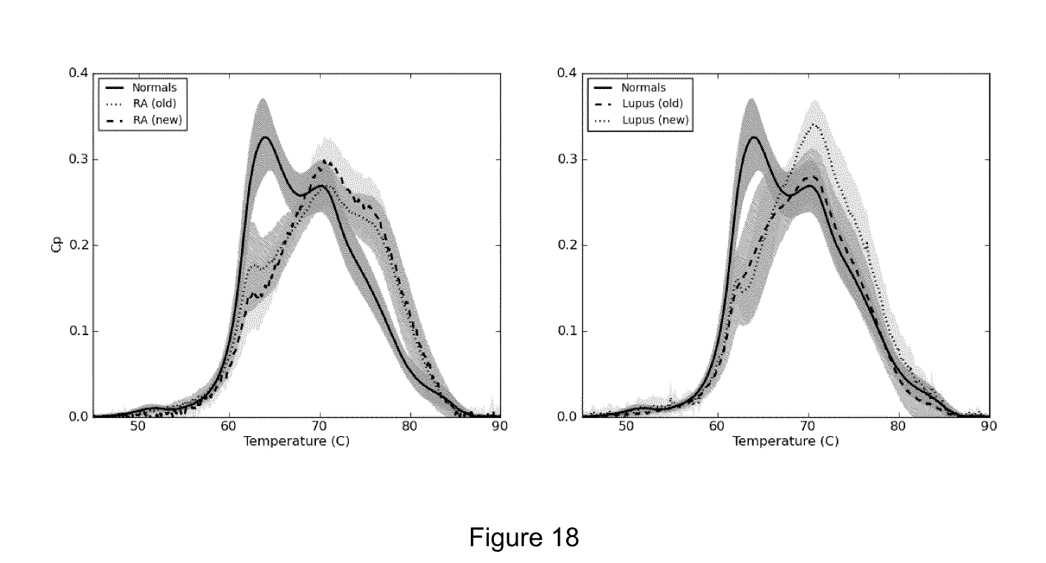

Data from RA and SLE disease categories were compared to data in the database from previously collected samples. Mean DSC plasma thermograms from each set were found to be remarkably consistent for each disease category (see, e.g., FIG. 18). This result is important for several reasons: 1) it indicates consistency between different sources; 2) it indicates that increasing sample sizes for SLE and RA will not significantly affect results; and 3) it indicates that the patterns for SLE and RA are ‘real’. For the current database design, one of ordinary skill in the art will recognize that similar database design approaches may be modified, and are considered to be within the spirit and scope of the original invention.

### Example 6

### Validation Study for Clinical Blinded Samples

Twenty-four de-identified, blinded samples were provided along with clinical demographic information listed in Table 6. Samples were dialyzed, their total protein concentration determined and DSC plasma thermograms were measured for each sample. Two independent DSC plasma thermograms were measured on two different differential scanning calorimeters. The measured DSC plasma thermogram for each sample was baseline corrected and normalized for total protein concentration. DSC plasma thermograms from replicate experiments were averaged and used in further analysis.

TABLE 6
Patient Demographic information: Age, Sex, Race, and Sample

| Sam- | | | Age at | | |
|---|---|---|---|---|---|
| ple | Study ID | Date Collected | Collection | Gender | Race |
| 1 | 1501007176 | Dec. 1, 2010 | 50 | F | White |
| 2 | 1501022711 | Dec. 1, 2010 | 74 | M | White |
| 3 | 1429027261 | Nov. 29, 2010 | 65 | M | White |
| 4 | 1430003427 | Nov. 30, 2010 | 66 | F | White |
| 5 | 1429013924 | Nov. 29, 2010 | 31 | F | White |
| 6 | 1429002085 | Nov. 29, 2010 | 54 | M | White |
| 7 | 1430004837 | Nov. 30, 2010 | 64 | M | White |
| 8 | 1430022248 | Nov. 30, 2010 | 66 | M | White |
| 9 | 1430026399 | Nov. 30, 2010 | 50 | F | American |
| | | | | | Indian/Ala |
| 10 | 1430002460 | Nov. 30, 2010 | 43 | F | Black/ |
| | | | | | African |
| | | | | | American |
| 11 | 1501005869 | Dec. 1, 2010 | 43 | M | Not Provided |
| 12 | 1501010528 | Dec. 1, 2010 | 62 | F | White |
| 13 | 1502011678 | Dec. 2, 2010 | 54 | F | Black/ |
| | | | | | African |
| | | | | | American |
| 14 | 1502010059 | Dec. 2, 2010 | 82 | F | White |
| 15 | 1502012600 | Dec. 2, 2010 | 42 | F | Asian |
| 16 | 1502007190 | Dec. 2, 2010 | 63 | F | White |
| 17 | 1502006604 | Dec. 2, 2010 | 36 | F | White |
| 18 | 1502002893 | Dec. 2, 2010 | 69 | M | White |
| 19 | 1503010513 | Dec. 3, 2010 | 55 | F | White |
| 20 | 1503018939 | Dec. 3, 2010 | 79 | M | White |
| 21 | 1507017117 | Dec. 7, 2010 | 71 | M | White |
| 22 | 1506002313 | Dec. 6, 2010 | 77 | M | Other |
| 23 | 1501021829 | Dec. 1, 2010 | 38 | F | White |
| 24 | 1508001794 | Dec. 8, 2010 | 70 | F | Not Provided |

A database of reference DSC plasma thermograms was compiled for a number of autoimmune diseases and other diseases including various cancers as well as for normal control subjects. In total, over 3,000 DSC plasma thermograms were included in the database. Reference DSC plasma thermograms from the database that were used for comparison and analysis are summarized in Table 7.

TABLE 7
Inventory of thermograms in the database used for comparison

| Disease State | Number of Thermograms |
|---|---|
| Normal | 179 |
| Lupus | 361 |
| RA | 39 |
| PM | 25 |
| Other | 188 |

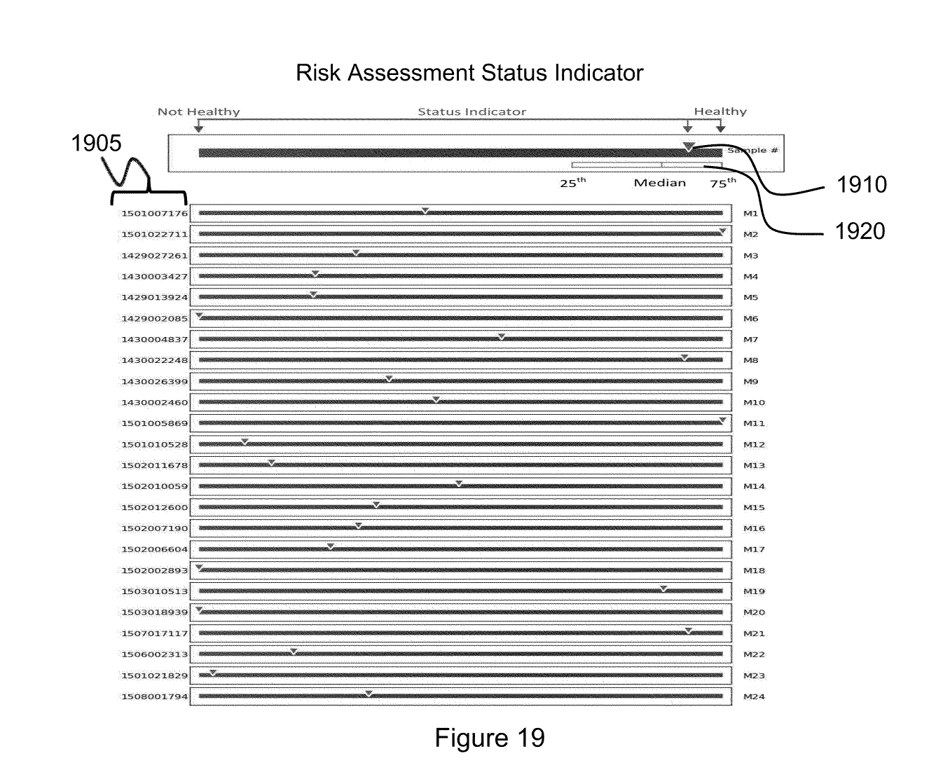

The “risk assessment status indicators” for the 24 DSC plasma thermograms are shown in FIG. 19. More specifically, the “risk assessment” status bar shows a score for each of the 24 subjects (1905) using a triangle marker (A; 1910) that is placed on the horizontal bar, wherein the further to the right the marker A, the more similar to normal control. In contrast, the further to the left, the more different from normal control (“not healthy”). The box shown below the example (1920) indicates the 25th-75th percentile range of similarity scores form all normal control DSC plasma thermograms in the database.

The 24 DSC plasma thermograms were then compared to reference DSC plasma thermograms in the database collected for subjects suffering from SLE, RA, PM, and normal control subjects. Comparisons of DSC plasma thermograms from the samples were made using statistical and chemometric pattern recognition methods, which may provide quantitative estimates on the statistical similarities of individual patterns with the normal control pattern, and similarities with the other three autoimmune disease DSC plasma thermograms in the database used for comparison. Results of these comparisons are summarized in Table 8.

TABLE 8
Gross classification of sample thermograms into one of three categories based upon their similarities

| | Sample Number | | | | | | | | | | | | | | | | | | | | | | | |
|---|---|---|---|---|---|---|---|---|---|---|---|---|---|---|---|---|---|---|---|---|---|---|---|---|
| Disease | 1 | 2 | 3 | 4 | 5 | 6 | 7 | 8 | 9 | 10 | 11 | 12 | 13 | 14 | 15 | 16 | 17 | 18 | 19 | 20 | 21 | 22 | 23 | 24 |
| Normal | — | X | — | — | — | — | X | X | — | — | X | — | — | — | — | — | — | — | X | — | X | — | — | — |
| Lupus | X | — | X | X | X | — | — | — | X | X | — | X | X | X | X | X | — | — | — | — | — | — | — | X |
| Other | — | — | — | — | — | X | — | — | — | — | — | — | — | — | — | — | X | X | — | X | — | X | X | — |

Table 8 shows the gross classification of sample DSC plasma thermograms into one of three categories based upon their similarities. More specifically, the analysis of the sample DSC plasma thermograms illustrate that there are 12-13 that are highly similar to SLE, four to six that are most similar to normal control, with the possible exceptions noted, and six to nine study sample DSC plasma thermograms not similar to normal control or SLE autoimmune reference DSC plasma thermograms. These are classified as “other.”

Sample 7 has a profile similar to normal control, but borderline with SLE, and samples 11 and 21 have similar shapes that are unlike the ‘typical’ normal control profile but still fall within the normal window. In the database of over 500 normal control DSC plasma thermograms, only a few had patterns similar to those for samples 11 and 21. In other examples, observation of the low temperature peak or shoulder on DSC plasma thermograms has been attributed to increased levels of haptoglobin. For these two samples, statistical analysis could not exclude the possibility of a normal (control) classification. Additional chemometric analysis, which is quite sensitive to subtle difference in curve shape, indicates a lower degree of similarity (from 60-75%) to the average normal control curve for these samples. To illustrate this finding, both normal control and other categories were highlighted for samples 11 and 21. Additionally, sample 19 has a profile more similar to normal control than anything in the database, but exhibits atypical features. Category “other” includes non SLE autoimmune disease, several cancer groups (such as lung, cervical, melanoma, ovarian), and various other disease categories.

TABLE 9
Autoimmune similarity ranking of similarity of study thermograms to reference thermograms
from three autoimmune categories and Normal thermograms in the database

| | Sample Number | | | | | | | | | | | | | | | | | | | | | | | |
|---|---|---|---|---|---|---|---|---|---|---|---|---|---|---|---|---|---|---|---|---|---|---|---|---|
| Disease | 1 | 2 | 3 | 4 | 5 | 6 | 7 | 8 | 9 | 10 | 11 | 12 | 13 | 14 | 15 | 16 | 17 | 18 | 19 | 20 | 21 | 22 | 23 | 24 |
| Normal | 2 | 1 | 3 | 3 | 3 | 4 | 3 | 1 | 2 | 3 | 1 | 2 | 3 | 2 | 2 | 2 | 3 | 4 | 1 | 4 | 1 | 4 | 4 | 3 |
| Lupus | 1 | 2 | 1 | 1 | 1 | 1 | 1 | 2 | 1 | 1 | 3 | 1 | 1 | 1 | 1 | 1 | 1 | 1 | 2 | 3 | 3 | 2 | 2 | 1 |
| RA | 3 | 3 | 2 | 2 | 2 | 3 | 2 | 3 | 3 | 2 | 2 | 3 | 2 | 3 | 3 | 3 | 2 | 3 | 3 | 2 | 2 | 1 | 1 | 2 |
| PM | 4 | 4 | 4 | 4 | 4 | 2 | 4 | 4 | 4 | 4 | 4 | 4 | 4 | 4 | 4 | 4 | 4 | 2 | 4 | 1 | 4 | 3 | 3 | 4 |

Table 9 shows the similarity ranking for autoimmune DSC plasma thermograms. More specifically, this table shows relative rankings of similarity of DSC plasma thermograms to reference DSC plasma thermograms from three autoimmune categories and normal control DSC plasma thermograms in the database. Each sample DSC plasma thermogram was compared to the normal control reference DSC plasma thermogram and reference DSC plasma thermograms from SLE, RA, and PM categories. Ranks were assigned in descending order according to their similarity (1=most similar, 4=least similar). It should be emphasized that these scores are relative within the autoimmune category. For example, sample 23 was most similar to the RA reference DSC plasma thermogram amongst reference DSC plasma thermograms from the autoimmune categories, but the absolute similarity to any reference DSC plasma thermogram was relatively quite low (see, e.g., FIG. 19 and Table 8).

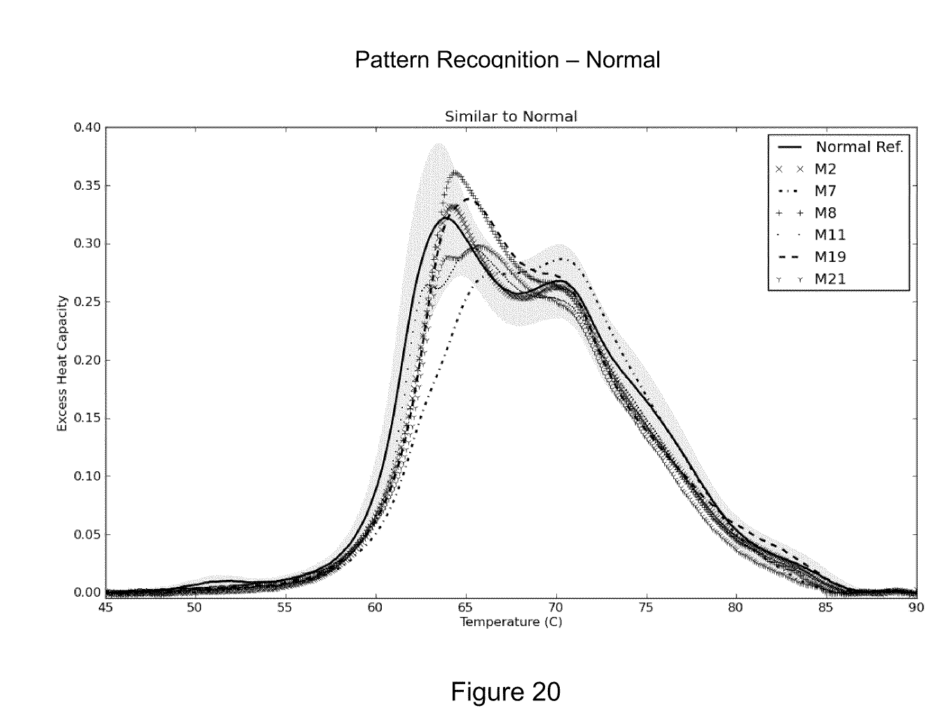

Pattern recognition of sample DSC plasma thermograms that were similar to normal control is shown in FIG. 20. This plot shows that samples 7 and 19 (dashed lines) are “borderline normal,” statistically similar to normal control, but clearly atypical by visual inspection. Further, samples 11 and 21 are quite similar to one another, but both display subtle departures from the normal control reference DSC plasma thermogram in the temperature region from 60° C.-65° C. The average normal control reference DSC plasma thermogram is given by the fine dotted line. The shaded region indicates one standard deviation from the normal control reference DSC plasma thermogram.

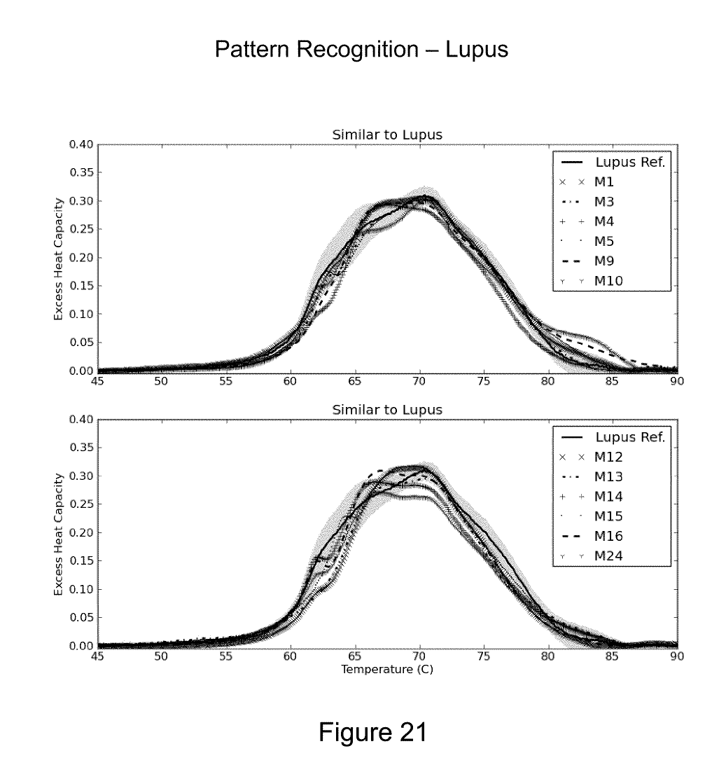

Sample DSC plasma thermograms similar to SLE are shown in FIG. 21. Twelve (12) samples are shown in this figure, however, for clarity, sample DSC plasma thermograms are shown in two plots. The SLE reference DSC plasma thermogram is indicated by the fine dotted line. The shaded region indicates one standard deviation from the SLE reference DSC plasma thermogram. One of ordinary skill in the art may visualize how the DSC plasma thermograms overlap in a disease-specific pattern. To illustrate the differences, the plots in FIG. 21 can be visually compared to normal control plots shown in FIG. 20.

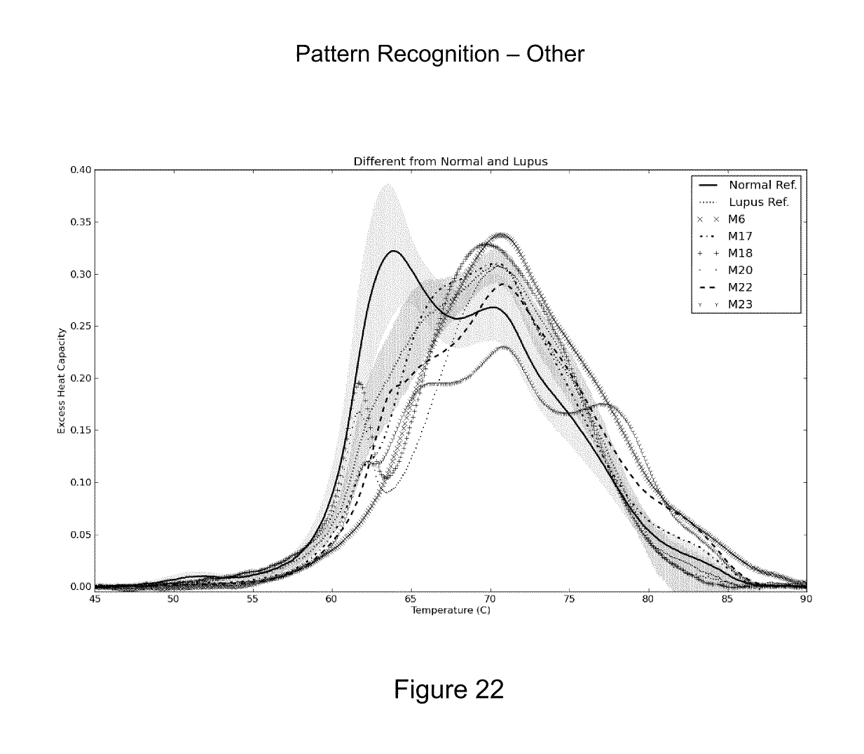

Moreover, another type of DSC plasma thermogram was categorized as neither being similar to normal control nor any autoimmune disease in the reference database, as shown in FIG. 22. More specifically, the SLE reference DSC plasma thermogram is given by the fine dashed line, the normal control reference DSC plasma thermogram is given by the solid line, and the other samples (e.g., M6, M17, M18, M20, M22, and M23) are shown as not fitting into the pattern of either normal control or SLE. The shaded regions indicate one standard deviation from the normal control and SLE reference DSC plasma thermograms. One of ordinary skill in the art may visualize how the DSC plasma thermograms overlap into three specific patterns: (i) normal control; (ii) SLE; and (iii) other in FIG. 22.

### Example 7

### Inflammatory vs. Non-Inflammatory Diseases

In another example, Clinical diagnosis and DSC plasma thermogram data for the 24 samples shown in Table 6 were reanalyzed for inflammatory vs. non-inflammatory diseases. This analysis found clustering of DSC plasma thermogram patterns for inflammatory versus non-inflammatory diseases. This finding led to a new DSC plasma thermogram reference set that could be constructed from existing SLE and RA DSC plasma thermograms. Data from the 24 samples was then reanalyzed along the lines of inflammatory vs. non-inflammatory. Note, this comparison is inherently different in that no attempt was made to stratify inflammatory diseases along specific lines such as SLE, RA, scleroderma, and myositis as done in the original comparison. The reference DSC plasma thermogram set was used to make comparisons and classifications of sample data into either inflammatory or non-inflammatory categories.

Table 10 shows the clinical classification as inflammatory versus non-inflammatory for the 24 samples. When DSC plasma thermograms were compared to their clinical classification as either inflammatory or non-inflammatory, classification of 20 out of 24 sample DSC plasma thermograms was consistent with clinical categorization.

TABLE 10
Patient Diagnostic Information

| | ANA | | |
|---|---|---|---|
| Sample | Result | Primary Diagnosis | Inflammatory |
| 1 | 0.6 | Chronic Dermatitis | 1 |
| 2 | 0.6 | Fibromyalgia | 0 |
| 3 | 3 | s/p Gastric by-pass | 1 |
| 4 | 0.3 | Ulcerative Colitis | 1 |
| 5 | 5.5 | Biopsy Proven Micro PAN | 1 |
| 6 | >12.0 | Endstage liver disease | 1 |
| 7 | 2 | PBC | 1 |
| 8 | 0.1 | Right Cavernous Sinus Tumor | 0 |
| 9 | 6.4 | Fibromyalgia | 0 |
| 10 | >12.0 | Rheumatoid Arthritis | 1 |
| 11 | 0.7 | Carotid Stenosis | 0 |
| 12 | 0.2 | Osteoarthritis | 0 |
| 13 | 0.2 | Rheumatoid Arthritis | 1 |
| 14 | 1.6 | Lupus | 1 |
| 15 | 5.1 | Psoriatic Arthritis | 1 |
| 16 | 2.3 | Musculoskelatal Pain | 1 |
| 17 | 11.2 | Sjogrens Syndrome | 1 |
| 18 | 1.5 | Polymyalgia rheumatica | 1 |
| 19 | 11.2 | Drug induced Lupus/Scleroderma | 1 |
| 20 | 3.5 | Renal Failure DM Type II | 0 |
| 21 | 3.8 | CLL | 1 |
| 22 | >12.0 | Sjogrens, Lab only | 1 |
| 23 | 3.8 | MGUS | 0 |
| 24 | 1.9 | ALS with ANCA vasculitis | 1 |

Inflammatory = 1
Non-inflammatory = 0

Several DSC plasma thermograms from the samples were found to be significantly different from normal control and any other autoimmune disease DSC plasma thermograms in compiled DSC plasma thermogram databases. These “other” DSC plasma thermograms were compared to additional DSC plasma thermograms in the database for subjects diagnosed with either of several different types of cancer (including melanoma, cervical, ovarian, and endometrial cancers) or other diseases (including lung and heart disease). In some cases, DSC plasma thermograms from the samples were highly dissimilar from normal control and autoimmune disease DSC plasma thermograms, but were quite similar to some of these other DSC plasma thermograms in the database. These results are shown in Table 8. A few DSC plasma thermograms exhibited shapes not previously observed for any disease sample examined. Notes to this effect have been included where appropriate. For the current database design, one of ordinary skill in the art will recognize that similar database design approaches may be modified and are considered to be within the spirit and scope of the disclosure.

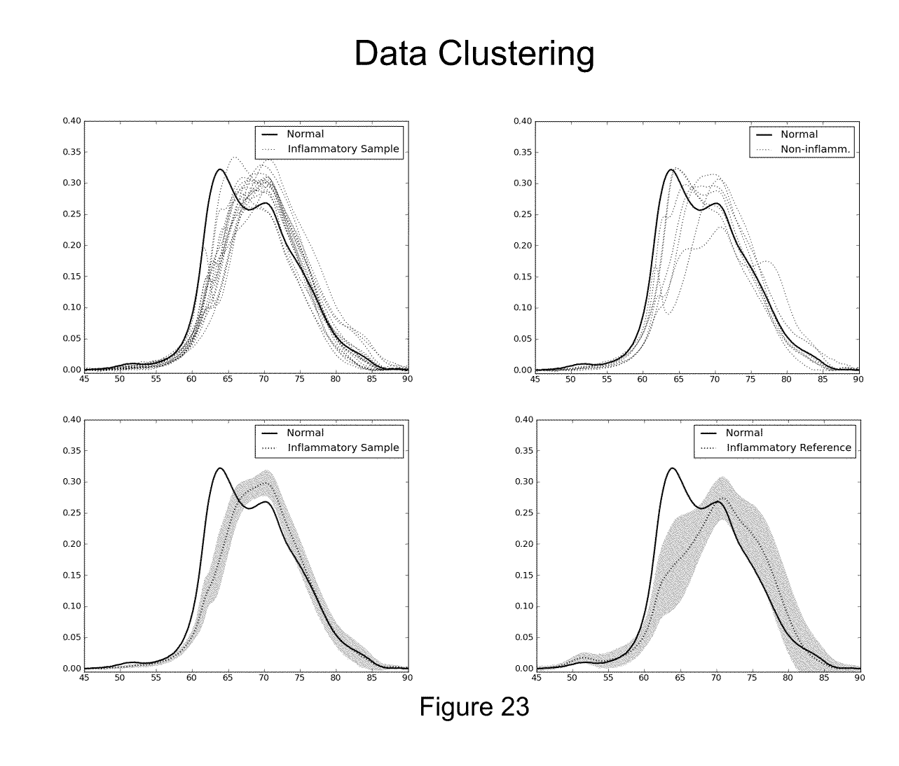

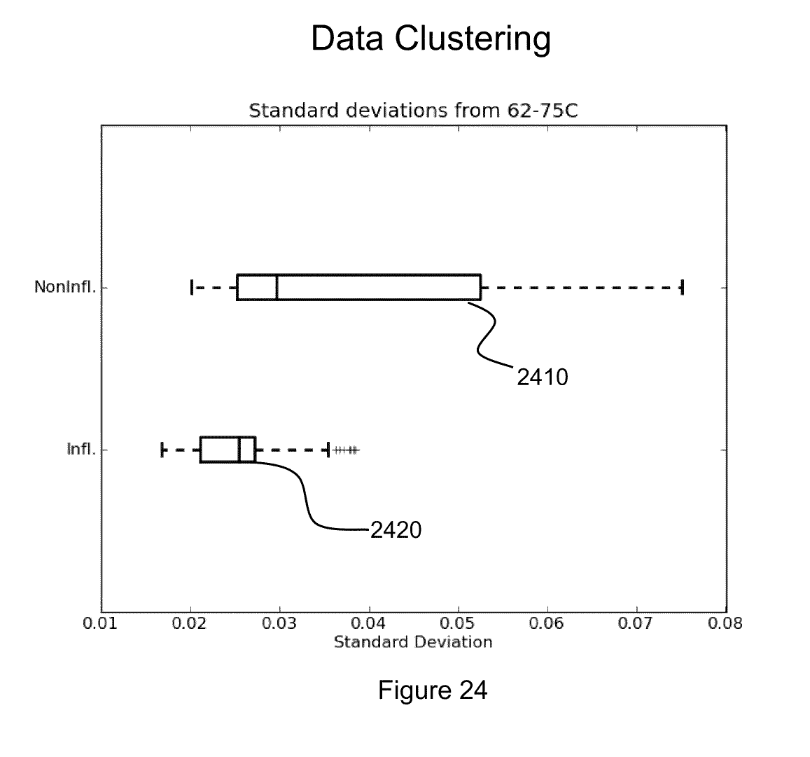

A natural clustering of inflammatory DSC plasma thermograms is shown in FIG. 23 (left panels). Without being bound by theory, this observation led to the formation of the inflammatory reference DSC plasma thermogram category, as shown in the bottom right of FIG. 23, which was established from existing SLE and RA DSC plasma thermograms in the database. Non-inflammatory DSC plasma thermograms appear to have much more variation when compared to inflammatory disease DSC plasma thermograms, as shown in FIG. 24. More specifically, FIG. 24 represents the variance for the inflammatory samples (2420) and non-inflammatory samples (2410). Without being bound by theory, it is believed that the much lower variance observed among inflammatory samples indicates similarity of DSC plasma thermogram patterns and provides an indication of the ability to discriminate between inflammatory and non-inflammatory DSC plasma thermograms.

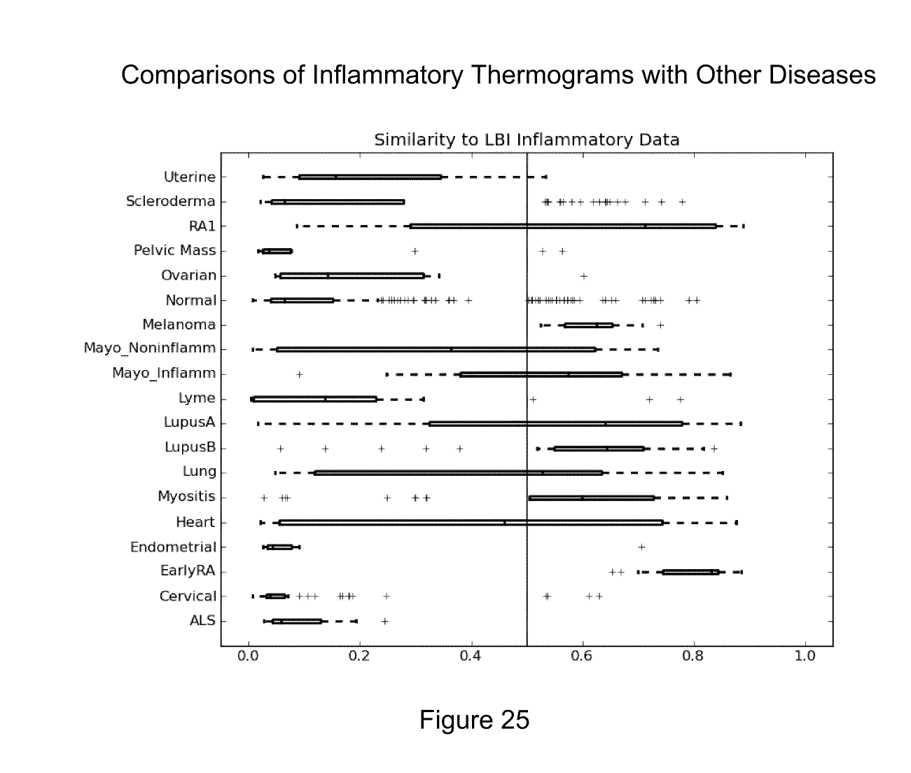

Next, the DSC plasma thermograms in the database were compared to the inflammatory reference DSC plasma thermogram, as shown FIG. 25. A high similarity was found for the inflammatory sample data, as well as other diseases including SLE, arthritis, melanoma and myositis. Little or low similarity was found for most cancers and other non-inflammatory categories such as Lyme disease, ALS, and normal control. Interestingly, for heart and lung disease, the similarity spans both inflammatory and non-inflammatory categories.

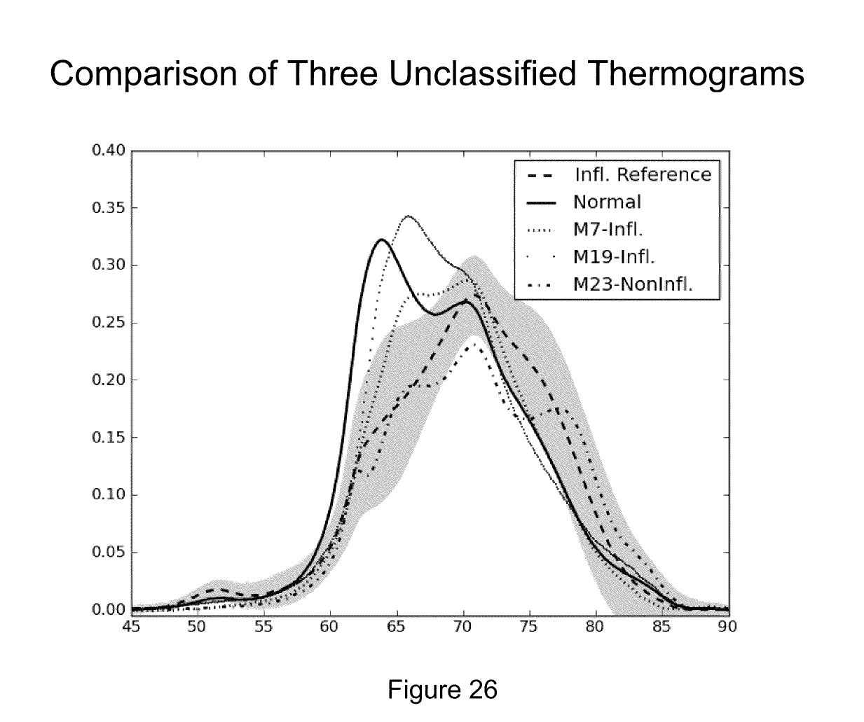

At least three samples could not be classified as either inflammatory or non-inflammatory (7, 19, and 23). Analysis of these DSC plasma thermograms indicated that the M7 DSC plasma thermogram was inflammatory, while the M23 DSC plasma thermogram was non-inflammatory, as shown in FIG. 26. The DSC plasma thermogram for sample M19 was indeterminate, and did not fall fully into one category or the other.

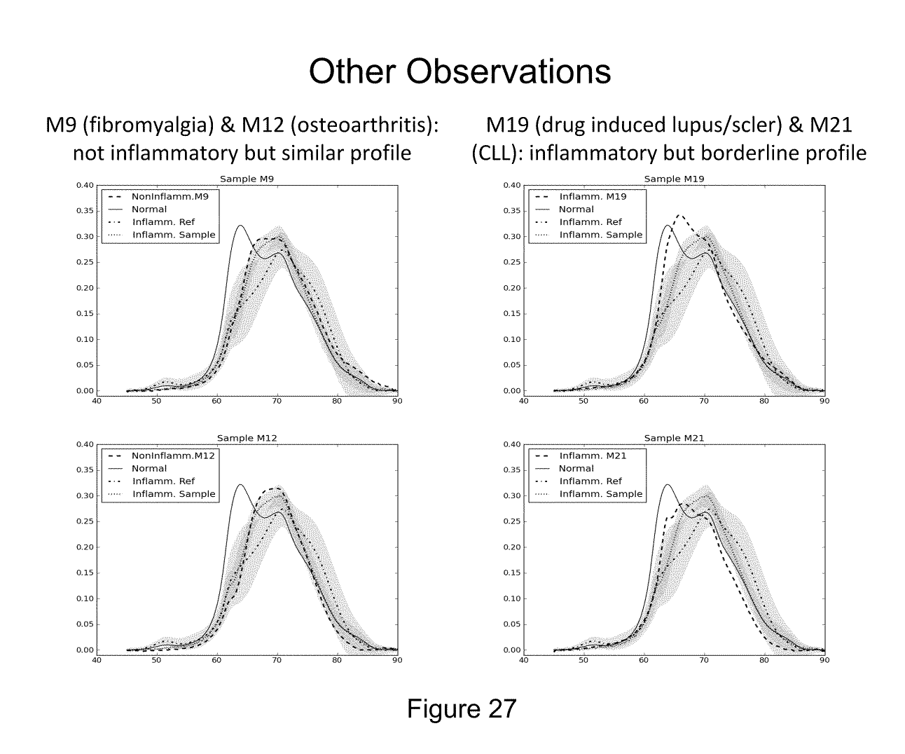

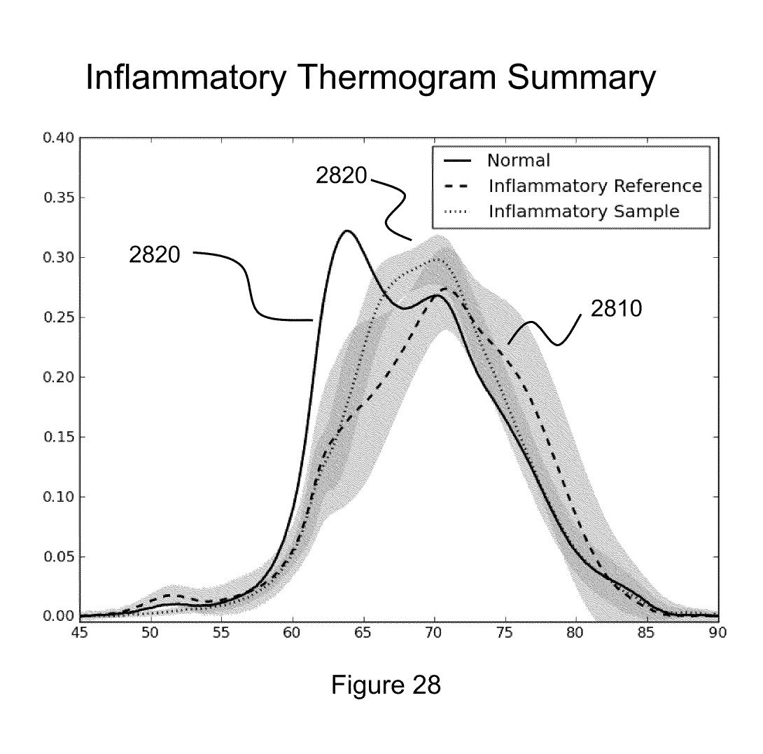

DSC plasma thermogram profiles were consistent with a clinical classification of inflammatory versus non-inflammatory, as shown in FIG. 27. In retrospect, consistent DSC plasma thermogram patterns in the inflammatory category were consistent with clinical diagnosis for 20/24, or 83%. Samples M9 and M12 (left) were clinically classified as non-inflammatory but had DSC plasma thermograms similar to the inflammatory reference DSC plasma thermogram. In contrast, samples M19 and M21 (right) were clinically classified as inflammatory, but displayed DSC plasma thermograms that were in borderline agreement with the inflammatory reference DSC plasma thermograms. Thus, clustering of inflammatory data indicated excellent discrimination, and a set of reference DSC plasma thermograms for inflammatory disease was developed that may be used in assays for discrimination between inflammatory and non-inflammatory diseases, as shown in FIG. 28.

### Example 8

### Systems for Identifying an Inflammatory Disease from a Biological Fluid

Disclosed herein in one specific embodiment is a system for identifying a biological fluid having an attribute of at least one pre-characterized inflammatory disease category. In various embodiments, the system may include a means for generating a plurality of heat capacity values from the biological fluid over a range of temperatures, a means for detecting the plurality of heat capacity values, and a means for forming a DSC thermogram data set from the plurality of heat capacity values. In various embodiments, the means for generating and/or detecting the plurality of heat capacity values may be in signal communication with a computing system that may be configured to categorize the DSC plasma thermogram data set as being (a) within the quantile boundaries of a pre-characterized inflammatory disease category, or (b) outside the quantile boundaries of the pre-characterized inflammatory disease category, for example by applying a similarity metric (ρ). In particular embodiments, the similarity metric (ρ) may include the combination of a distance metric (P) and a correlation coefficient (r), and in even more particular embodiments, the correlation coefficient (r) may include a Kendal's tau linear correlation.

In some embodiments, the computing system may be in signal communication with a means for signaling a user of the system that the biological fluid has been categorized as being within the quantile boundaries of the pre-characterized inflammatory disease category. In some embodiments, the biological fluid may be blood, plasma, cerebral spinal fluid (CSF), bone marrow, urine, saliva, sweat, and in particular embodiments, the biological fluid may be plasma.

In some embodiments, the pre-characterized inflammatory disease category may be an autoimmune disease category, and in particular embodiments, the autoimmune disease category may be a celiac disease category, an IDDM category, a SLE category, a Sjögren's syndrome category, a Churg-Strauss syndrome category, a Hashimoto's thyroiditis category, a Graves' disease category, an idiopathic thrombocytopenic purpura category, an RA category, an MS category, a myositis category, or a combination thereof. In some embodiments, the means for detecting the plurality of heat capacity values may include a differential scanning calorimeter, and in particular embodiments, the differential scanning calorimeter may be a GE MicroCal DSC, a TA Instruments DSC, or a Perkin Elmer DSC.

### Example 9

### Methods for Identifying an Autoimune Disease from a Biological Fluid

Disclosed herein in another specific embodiment is a method for categorizing an isolated biological fluid into at least one pre-characterized inflammatory disease category. In various embodiments, the method may involve heating the isolated biological fluid over a range of temperatures with a differential scanning calorimeter to generate a plurality of heat capacity data values, and forming a test sample DSC plasma thermogram data set from the plurality of heat capacity data values. In some embodiments, the method also may include categorizing the test sample DSC plasma thermogram data set as being either within the quantile boundaries of a pre-characterized autoimmune disease category or outside the quantile boundaries of the pre-characterized autoimmune disease category, for instance by applying a similarity metric (ρ). In some embodiments, the method also may include signaling a user of the system when the biological fluid is categorized as being within the quantile boundaries of the pre-characterized inflammatory disease category.

In some embodiments, the biological fluid may be blood, plasma, bone marrow, CSF, urine, saliva, or sweat, and in particular embodiments, the biological fluid may be plasma. In other embodiments of the method, the inflammatory disease category may be an autoimmune disease category, such as a celiac disease category, an IDDM category, a SLE category, a Sjögren's syndrome category, a Churg-Strauss syndrome category, a Hashimoto's thyroiditis category, a Graves' disease category, an idiopathic thrombocytopenic purpura category, an RA category, an MS category, a myositis category, or a combination thereof. In additional embodiments, the differential scanning calorimeter may be a GE MicroCal DSC, a TA Instruments DSC, or a Perkin Elmer DSC.

In various embodiments, the similarity metric (ρ) may include a combination of a distance metric (P) and a correlation coefficient (r), and in particular embodiments, the correlation coefficient (r) may include a Kendal's tau linear correlation.

### Example 10

### Methods of Monitoring an Autoimmune Disease or an Autoimmune Disease Treatment in a Subject

In another specific embodiment, methods are provided for monitoring an inflammatory disease in a subject. In various embodiments, the method may include collecting a first body fluid sample from the subject at a first time point, generating a first signature DSC plasma thermogram from the body fluid sample using a differential scanning calorimeter, collecting a second-body fluid sample from the subject at a second-time point, generating a second signature DSC plasma thermogram from the second body fluid sample, and comparing the first signature DSC plasma thermogram to the second signature DSC plasma thermogram. In various embodiments, a shift in the second signature DSC plasma thermogram relative to the first signature DSC plasma thermogram may be in a direction that is closer to a normal control DSC plasma thermogram, which would indicate an amelioration of the inflammatory disease, or it may be in a direction that is farther away from a normal control DSC plasma thermogram, which would indicate a worsening of the inflammatory disease.

In some embodiments, comparing the first signature DSC plasma thermogram to the second signature DSC plasma thermogram may include applying a similarity metric (ρ) to categorize the second signature DSC plasma thermogram as being either within quantile boundaries of the first signature DSC plasma thermogram, or outside the quantile boundaries of the first signature DSC plasma thermogram. In various embodiments, if the second signature DSC plasma thermogram is within quantile boundaries of the first signature DSC plasma thermogram, this may indicate a lack of change in the inflammatory disease. However, if the second signature DSC plasma thermogram is outside the quantile boundaries of the first signature DSC plasma thermogram, this may indicate either an amelioration or a worsening of the autoimmune disease, depending on whether the change is in a direction that is closer to a normal control DSC plasma thermogram, or in a direction that is farther away from a normal control DSC plasma thermogram.

Some embodiments also include signaling a user of the system when the first biological fluid and second biological fluid are categorized as being within the quantile boundaries of the pre-characterized inflammatory disease category, when the second signature DSCplasma thermogram is shifted in a direction that is closer to a normal control DSC plasma thermogram (relative to the first signature DSC plasma thermogram), or when the second signature DSC plasma thermogram is shifted in a direction that is farther from a normal control DSC plasma thermogram (relative to the first signature DSC plasma thermogram).

In some embodiments, the biological fluid may be blood, plasma, bone marrow, CSF, urine, saliva, or sweat, and in particular embodiments, the biological fluid may be plasma. In some embodiments, the inflammatory disease may be an autoimmune disease, such as celiac disease, IDDM, SLE, Sjögren's syndrome, Churg-Strauss syndrome, Hashimoto's thyroiditis, Graves' disease, idiopathic thrombocytopenic purpura, RA, MS, myositis, or a combination thereof. In additional embodiments, the differential scanning calorimeter may be a GE MicroCal DSC, a TA Instruments DSC, or a Perkin Elmer DSC.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. A system for identifying a biological fluid having at least one attribute of a pre-characterized inflammatory disease category, the system comprising:
a means for generating a plurality of heat capacity values from the biological fluid over a range of temperatures;
a means for detecting the plurality of heat capacity values;
a means for forming a DSC plasma thermogram data set from the plurality of heat capacity values;
wherein the means for generating the plurality of heat capacity values is in signal communication with a computing system configured to categorize the DSC plasma thermogram data set as being:
(a) within the quantile boundaries of the pre-characterized inflammatory disease category; or
(b) outside of the quantile boundaries of the pre-characterized inflammatory disease category.

2. The system of claim 1, wherein the pre-characterized autoimmune disease category is an autoimmune disease category.

3. The system of claim 2, wherein the autoimmune disease category comprises a celiac disease category, a diabetes mellitus type 1 category, a systemic lupus erythematosus category, a Sjögren's syndrome category, a Churg-Strauss syndrome category, a Hashimoto's thyroiditis category, a Graves' disease category, an idiopathic thrombocytopenic purpura, category, a rheumatoid arthritis category, a multiple sclerosis category, or a combination thereof.

4. The system of claim 1, wherein the biological fluid comprises blood, plasma, bone marrow, cerebral spinal fluid, urine, saliva, or sweat.

5. The system of claim 4, wherein the biological fluid comprises plasma.

6. The system claim 1, wherein:
the means for generating the plurality of heat capacity values;
the means for detecting the plurality of heat capacity values; and/or
the means for forming the DSC plasma thermogram data set from the plurality of heat capacity values;
comprises a differential scanning calorimeter.

7. The system of claim 1, wherein the computing system is in signal communication with a means for signaling a user of the system that the biological fluid is categorized within the quantile boundaries of the pre-characterized inflammatory disease category.

8. The system of claim 1, wherein the computing system is configured to categorize the DSC plasma thermogram data set as being: (a) within the quantile boundaries of the pre-characterized inflammatory disease category; or (b) outside of the quantile boundaries of the pre-characterized inflammatory disease category by applying a similarity metric (ρ), wherein the similarity metric (ρ) comprises the combination of a distance metric (P) and a correlation coefficient (r).

9. A method for categorizing an isolated biological fluid into at least one pre-characterized inflammatory disease category, the method comprising:
heating the isolated biological fluid over a range of temperatures with a differential scanning calorimeter;
generating a plurality of heat capacity data values for the biological fluid;
forming a DSC plasma thermogram data set from the plurality of heat capacity data values; and
categorizing the DSC plasma thermogram data set as being:
(a) within the quantile boundaries of the pre-characterized inflammatory disease category; or
(b) outside of the quantile boundaries of the pre-characterized inflammatory disease category.

10. The method of claim 9, wherein the pre-characterized autoimmune disease category is an autoimmune disease category.

11. The method of claim 10, wherein the autoimmune disease category comprises a celiac disease category, a diabetes mellitus type 1 category, a systemic lupus erythematosus category, a Sjögren's syndrome category, a Churg-Strauss syndrome category, a Hashimoto's thyroiditis category, a Graves' disease category, an idiopathic thrombocytopenic purpura, category, a rheumatoid arthritis category, a multiple sclerosis category, or a combination thereof.

12. The method of claim 9, wherein the biological fluid comprises blood, plasma, bone marrow, cerebral spinal fluid, urine, saliva, or sweat.

13. The method of claim 12, wherein the biological fluid comprises plasma.

14. The method of claim 9, further comprising signaling a user when the biological fluid is categorized within the quantile boundaries of the pre-characterized inflammatory disease category.

15. The method of claim 9, wherein categorizing the DSC plasma thermogram data set as being: (a) within the quantile boundaries of the pre-characterized inflammatory disease category; or (b) outside of the quantile boundaries of the pre-characterized inflammatory disease category comprises applying a similarity metric (ρ), wherein the similarity metric (ρ) comprises the combination of a distance metric (P) and a correlation coefficient (r).

16. A method for monitoring a pre-characterized inflammatory disease in a subject, the method comprising:
collecting a first body fluid sample from the subject at a first time point;
generating a first signature DSC plasma thermogram from the first body fluid sample using a differential scanning calorimeter;
collecting a second body fluid sample from the subject at a second time point;
generating a second signature DSC plasma thermogram from the second body fluid sample; and
comparing the first signature DSC plasma thermogram to the second signature DSC plasma thermogram,
wherein a shift in the second signature DSC plasma thermogram relative to the first signature DSC plasma thermogram in a direction that is closer to a normal control DSC plasma thermogram indicates an amelioration of the inflammatory disease, and
wherein a shift in the second signature DSC plasma thermogram relative to the first signature DSC plasma thermogram in a direction that is farther away from a normal control DSC plasma thermogram indicates a worsening of the inflammatory disease.

17. The method of claim 16, wherein the pre-characterized autoimmune disease is an autoimmune disease category.

18. The method of claim 17, wherein the autoimmune disease comprises celiac disease, diabetes mellitus type 1, systemic lupus erythematosus, Sjögren's syndrome, Churg-Strauss syndrome, Hashimoto's thyroiditis, Graves' disease, idiopathic thrombocytopenic purpura, rheumatoid arthritis, multiple sclerosis, or a combination thereof.

19. The method of claim 16, wherein the biological fluid comprises blood, plasma, bone marrow, cerebral spinal fluid, urine, saliva, or sweat.

20. The method of claim 19, wherein the biological fluid comprises plasma.

21. A method for categorizing an isolated biological fluid into at least one pre-characterized neoplastic disease category, the method comprising:
heating the isolated biological fluid over a range of temperatures with a differential scanning calorimeter;
generating a plurality of heat capacity data values for the biological fluid;
forming a DSC plasma thermogram data set from the plurality of heat capacity data values; and
categorizing the DSC plasma thermogram data set as being:
(a) within the quantile boundaries of the pre-characterized neoplastic disease category; or
(b) outside of the quantile boundaries of the pre-characterized neoplastic disease category.

22. The method of claim 21, wherein the biological fluid comprises plasma.

23. The method of claim 21, wherein categorizing the DSC plasma thermogram data set as being: (a) within the quantile boundaries of the pre-characterized neoplastic disease category; or (b) outside of the quantile boundaries of the pre-characterized neoplastic disease category comprises applying a similarity metric (ρ), wherein the similarity metric (ρ) comprises the combination of a distance metric (P) and a correlation coefficient (r).

24. The method of claim 21, wherein the neoplastic disease is cervical cancer, skin cancer, lung cancer, ovarian cancer, uterine cancer, or endometrial cancer.
